(19) United States
(12) Patent Application Publication
(10) Pub. No.: US 2025/0180083 A1
(43) Pub. Date: Jun. 5, 2025

(54) DISC BRAKE CALIPER

(71) Applicant: Shimano Inc., Osaka (JP)

(72) Inventor: Kazuma MORI, Osaka (JP)

(21) Appl. No.: 18/524,672

(22) Filed: Nov. 30, 2023

(51) Int. Cl. F16D 65/00; B62L 3/02; F16D 55/00; F16D 55/228; F16D 65/18; F16D 121/04

(52) U.S. Cl. CPC F16D 65/0075; B62L 3/023; F16D 55/228; F16D 65/18; F16D 2055/002; F16D 2121/04

(57) ABSTRACT

A disc brake caliper is provided for a human-powered vehicle. The disc brake caliper basically includes a hydraulic caliper body and a first hydraulic piston. The hydraulic caliper body includes a first cylinder and a first attachment portion configured to couple a mechanical caliper body being configured to be operated by a cable. The first hydraulic piston is movably provided in the first cylinder to move a first brake pad into contact with a rotor, the first hydraulic piston being configured to be operated by a hydraulic fluid.

### BACKGROUND

### Technical Field

This disclosure generally relates to a disc brake caliper for human-powered vehicles such as bicycles.

### Background Information

Generally, there are several types of brake devices currently available on the market for human-powered vehicles, e.g., bicycles. Examples of some types of common bicycle brake devices include rim brakes and disc brakes. Disc brakes have become more popular for human-powered vehicles such as bicycles. In particular, disc brakes provide substantial braking power in relation to an amount of braking force applied to a brake lever or a pedal as compared to rim brakes. Moreover, disc brake systems typically provide a high level of braking consistency in all types of weather and riding conditions. Disc brakes can be either cable operated or hydraulically operated.

### SUMMARY

Generally, the present disclosure is directed to various features of a disc brake caliper for a human-powered vehicle. The term “human-powered vehicle” as used herein refers to a vehicle that can be propelled by at least human driving force to produce propulsion, but does not include a vehicle using only a driving power other than human power. In particular, a vehicle solely using an internal combustion engine as a driving power is not included in the human-powered vehicle. The human-powered vehicle is generally assumed to be a compact, light vehicle that sometimes does not require a license for driving on a public road. The number of wheels on the human-powered vehicle is not limited. The human-powered vehicle includes, for example, a monocycle and a vehicle having three or more wheels. The human-powered vehicle includes, for example, various types of bicycles such as a mountain bike, a road bike, a city bike, a cargo bike, and a recumbent bike, and an electric assist bicycle (E-bike).

In view of the state of the known technology and in accordance with a first aspect of the present disclosure, a disc brake caliper is provided for a human-powered vehicle. The disc brake caliper basically comprises a hydraulic caliper body and a first hydraulic piston. The hydraulic caliper body includes a first cylinder and a first attachment portion configured to couple a mechanical caliper body being configured to be operated by a cable. The first hydraulic piston is movably provided in the first cylinder to move a first brake pad into contact with a rotor, the first hydraulic piston being configured to be operated by a hydraulic fluid.

With the disc brake caliper according to the first aspect, the disc brake caliper can have a relatively compact configuration while providing both mechanical braking and hydraulic braking.

In accordance with a second aspect of the present disclosure, the disc brake caliper according to the first aspect is configured so that the first attachment portion is configured to detachably couple the mechanical caliper body thereto.

With the disc brake caliper according to the second aspect, it is possible to detach the mechanical caliper body from the hydraulic caliper body such that the maintenance can be performed on the mechanical caliper body.

In accordance with a third aspect of the present disclosure, the disc brake caliper according to the second aspect further comprises a first fixing member configured to detachably couple the mechanical caliper body to the first attachment portion of the hydraulic caliper body.

With the disc brake caliper according to the third aspect, the mechanical caliper body can be easily detached from the hydraulic caliper body.

In accordance with a fourth aspect of the present disclosure, the disc brake caliper according to the second aspect or the third aspect is configured so that the hydraulic caliper body further includes a second attachment portion that is offset from the first attachment portion.

With the disc brake caliper according to the fourth aspect, the disc brake caliper can have a relatively compact configuration.

In accordance with a fifth aspect of the present disclosure, the disc brake caliper according to the fourth aspect is configured so that the first attachment portion is provided on an outbound side of the hydraulic caliper body and the second attachment portion is provided on an inbound side of the hydraulic caliper body.

With the disc brake caliper according to the fifth aspect, the mechanical caliper body can be firmly and reliably coupled to the hydraulic caliper body.

In accordance with a sixth aspect of the present disclosure, the disc brake caliper according to the fourth aspect or the fifth aspect further comprises a second fixing member configured to detachably attach the second attachment portion to the mechanical caliper body.

With the disc brake caliper according to the sixth aspect, the mechanical caliper body can be easily coupled to the hydraulic caliper body in a detachable manner.

In accordance with a seventh aspect of the present disclosure, the disc brake caliper according to the sixth aspect is configured so that the first fixing member has a first fixing axis and the second fixing member has a second fixing axis that is parallel to the first fixing axis in a state where the first fixing member and the second fixing member are attached to the hydraulic caliper body.

With the disc brake caliper according to the seventh aspect, the disc brake caliper can have a relatively compact configuration.

In accordance with an eighth aspect of the present disclosure, the disc brake caliper according to any one of the first aspect to the seventh aspect further comprises the mechanical caliper body coupled to the hydraulic caliper body.

With the disc brake caliper according to the eighth aspect, the braking force applied to a rotor can be varied based on which of the mechanical piston and the first hydraulic piston is used for braking. Also, the mechanical piston can be used as a parking brake and the first hydraulic piston can be used during normal riding.

In accordance with a ninth aspect of the present disclosure, the disc brake caliper according to the eighth aspect is configured so that the mechanical caliper body is positioned on an upstream side of the hydraulic caliper body relative to a rotational direction of the rotor.

With the disc brake caliper according to the ninth aspect, the mechanical caliper body can be easily accessed for repair.

In accordance with a tenth aspect of the present disclosure, the disc brake caliper according to the eighth aspect or the ninth aspect further comprises a mechanical piston movably provided in the mechanical caliper body and configured to move a brake pad into contact with the rotor.

With the disc brake caliper according to the tenth aspect, a braking force can be reliably applied to a rotor.

In accordance with an eleventh aspect of the present disclosure, the disc brake caliper according to the tenth aspect further comprises an intermediate member movably provided in the mechanical caliper body and having a cable attachment portion configured to be coupled to a cable. The intermediate member is configured to move the mechanical piston in response to movement of the cable during a braking operation.

With the disc brake caliper according to the eleventh aspect, the mechanical piston can be moved using a cable.

In accordance with a twelfth aspect of the present disclosure, the disc brake caliper according to any one of the eighth aspect to the eleventh aspect is configured so that the mechanical caliper body includes a caliper housing defining a rotor receiving slot.

With the disc brake caliper according to the twelfth aspect, a rotor can be received in the rotor receiving slot such that the mechanical piston can reliably apply a braking force to the rotor.

In accordance with a thirteenth aspect of the present disclosure, the disc brake caliper according to the twelfth aspect is configured so that the caliper housing has an interior space, and the intermediate member is disposed in the interior space.

With the disc brake caliper according to the thirteenth aspect, the intermediate member can be protected by the caliper housing.

In accordance with a fourteenth aspect of the present disclosure, the disc brake caliper according to the twelfth aspect or the thirteenth aspect is configured so that the mechanical caliper body includes a lid detachably coupled to the caliper housing.

With the disc brake caliper according to the fourteenth aspect, the mechanical caliper body can be relatively easy to repair.

In accordance with a fifteenth aspect of the present disclosure, the disc brake caliper according to the twelfth aspect or the fourteenth aspect is configured so that the caliper housing has a cable port provided on an inbound side of the rotor receiving slot.

With the disc brake caliper according to the fifteenth aspect, a cable can be conveniently routed to the caliper housing for operating the mechanical caliper body.

In accordance with a sixteenth aspect of the present disclosure, the disc brake caliper according to the twelfth aspect or the fifteenth aspect is configured so that the caliper housing includes an outbound portion having a first inner surface defining a first side of the rotor receiving slot, and an inbound portion having a second inner surface defining a second side of the rotor receiving slot.

With the disc brake caliper according to the sixteenth aspect, the rotor receiving slot can be approximately located.

In accordance with a seventeenth aspect of the present disclosure, the disc brake caliper according to the sixteenth aspect is configured so that the outbound portion has a piston bore, and the mechanical piston is slidably disposed in the piston bore.

With the disc brake caliper according to the seventeenth aspect, the construction of the disc brake caliper can be further simplified.

In accordance with an eighteenth aspect of the present disclosure, the disc brake caliper according to the sixteenth aspect or the seventeenth aspect is configured so that the intermediate member is pivotally supported to the outbound portion by a first shaft, and the outbound portion has a first shaft support recess receiving the first shaft.

With the disc brake caliper according to the eighteenth aspect, the intermediate member can be pivotally supported to the caliper housing without interfering with the wheel.

In accordance with a nineteenth aspect of the present disclosure, the disc brake caliper according to the eighteenth aspect is configured so that the intermediate member further includes an actuating arm extending radially from the first shaft with respect to a pivot axis of the first shaft. The actuating arm includes the cable attachment portion at a position spaced from the pivot axis.

With the disc brake caliper according to the nineteenth aspect, a cable pulling force can be reduced for a braking operation.

In accordance with a twentieth aspect of the present disclosure, the disc brake caliper according to any one of the twelfth aspect to the nineteenth aspect is configured so that the caliper housing includes a second shaft support recess configured to receive a brake pad shaft.

With the disc brake caliper according to the twentieth aspect, the brake pad of the mechanical caliper body can be easily provided to the caliper housing.

In accordance with a twenty-first aspect of the present disclosure, the disc brake caliper according to any one of the eleventh aspect to the twentieth aspect is configured so that the intermediate member further includes a first cam surface configured to move the mechanical piston.

With the disc brake caliper according to the twenty-first aspect, rotational movement of the intermediate member can be easily converted to linear movement of the mechanical piston.

In accordance with a twenty-second aspect of the present disclosure, the disc brake caliper according to the twenty-first aspect is configured so that the cable attachment portion and the cam portion are a one-piece member.

With the disc brake caliper according to the twenty-second aspect, the construction of the disc brake caliper can be simplified.

In accordance with a twenty-third aspect of the present disclosure, the disc brake caliper according to any one of the eleventh aspect to the twenty-second aspect is configured so that the intermediate member is configured to pivot about a pivot axis. The mechanical piston is configured to move along a mechanical piston axis. The pivot axis is different from the mechanical piston axis.

With the disc brake caliper according to the twenty-third aspect, the construction of the disc brake caliper can be simplified.

In accordance with a twenty-fourth aspect of the present disclosure, the disc brake caliper according to the twenty-third aspect is configured so that the pivot axis is not parallel to the mechanical piston axis.

With the disc brake caliper according to the twenty-fourth aspect, the disc brake caliper can have a relatively compact configuration.

In accordance with a twenty-fifth aspect of the present disclosure, the disc brake caliper according to the twenty-fourth aspect is configured so that the pivot axis is perpendicularly arranged relative to the mechanical piston axis.

With the disc brake caliper according to the twenty-fifth aspect, rotational movement of the intermediate member can be easily converted to linear movement of the mechanical piston.

In accordance with a twenty-sixth aspect of the present disclosure, the disc brake caliper according to any one of the eleventh aspect to the twenty-fifth aspect further comprises a biasing element configured to bias the intermediate member to a non-actuated position.

With the disc brake caliper according to the twenty-sixth aspect, the intermediate member can automatically return to a non-actuated position after a braking operation.

In accordance with a twenty-seventh aspect of the present disclosure, the disc brake caliper according to any one of the first aspect to the twenty-sixth aspect further comprises a second hydraulic piston movably provided in a second cylinder of the hydraulic caliper body to move a second brake pad into contact with the rotor.

With the disc brake caliper according to the twenty-seventh aspect, a firm braking force can be applied to the rotor by using the first hydraulic piston and the second hydraulic piston.

In accordance with a twenty-eighth aspect of the present disclosure, the disc brake caliper according to any one of the first aspect to the twenty-seventh aspect is configured so that the hydraulic caliper body includes a coupling portion configured to couple the hydraulic caliper body to a vehicle body of the human-powered vehicle.

With the disc brake caliper according to the twenty-eighth aspect, the disc brake caliper can be firmly and reliably secured to the human-powered vehicle.

In accordance with a twenty-ninth aspect of the present disclosure, the disc brake caliper according to the twenty-eighth aspect is configured so that the coupling portion includes a first coupling hole and a second coupling hole.

With the disc brake caliper according to the twenty-ninth aspect, the disc brake caliper can be easily secured to the human-powered vehicle in a detachably manner.

Also, other objects, features, aspects and advantages of the disclosed disc brake caliper will become apparent to those skilled in the art from the following detailed description, which, taken in conjunction with the annexed drawings, discloses preferred embodiments of the disc brake caliper.

### BRIEF DESCRIPTION OF THE DRAWINGS

Referring now to the attached drawings which form a part of this original disclosure.

FIG. 1 is a side elevational view of a human-powered vehicle (e.g., a bicycle) that is equipped with a disc brake system including a disc brake caliper (e.g., a bicycle disc brake caliper) having hydraulic caliper and a mechanical caliper in accordance with a first embodiment of the present disclosure.

FIG. 2 is a perspective view of the disc brake system including the disc brake caliper coupled to a bicycle frame and a brake operating (actuating) device that operates the disc brake caliper in accordance with the first embodiment.

FIG. 3 is a perspective view of the brake operating device of the disc brake system illustrated in FIG. 2 in which a first brake lever of the brake operating device has been operated to apply a first braking force.

FIG. 4 is a perspective view of the brake operating device illustrated in FIGS. 2 and 3 in which a second brake lever of the brake operating device has been operated to apply a second braking force.

FIG. 5 is a first cross-sectional view of the brake operating device illustrated in FIGS. 2 to 4 as taken along section plane perpendicular to a pivot axis of the second brake lever and passing through a cylinder axis of a cylinder bore provided in the base member.

FIG. 6 is a second cross-sectional view of the brake operating device illustrated in FIGS. 2 to 5 as taken along section plane parallel to the pivot axis of the brake lever and passing through the cylinder axis of the cylinder bore provided in the base member.

FIG. 7 is an outside perspective view of the disc brake caliper illustrated in FIG. 2.

FIG. 8 is an inside perspective view of the disc brake caliper illustrated in FIG. 7.

FIG. 9 is an outside elevational view of the disc brake caliper illustrated in FIGS. 7 and 8.

FIG. 10 is an inside elevational view of the disc brake caliper illustrated in FIGS. 7 to 9.

FIG. 11 is a top view of the disc brake caliper illustrated in FIGS. 7 to 10.

FIG. 12 is a bottom view of the disc brake caliper illustrated in FIGS. 7 to 11.

FIG. 13 is a top oblique view of the disc brake caliper illustrated in FIGS. 7 to 12 as viewed in a direction parallel to the fastening axes of the frame fasteners.

FIG. 14 is a rear oblique view of the disc brake caliper illustrated in FIGS. 7 to 13 as viewed in a direction perpendicular to the fastening axes of the frame fasteners.

FIG. 15 is an outside elevational view of the disc brake caliper illustrated in FIGS. 7 to 14 in which a lid of the disc brake caliper has been removed from the caliper housing and in which the mechanical caliper is in a non-braking state.

FIG. 16 is an outside elevational view, similar to FIG. 15, of the disc brake caliper but in which the mechanical caliper is in a braking state.

FIG. 17 is an outside perspective view of the disc brake caliper illustrated in FIGS. 7 to 16 but in which the mechanical caliper has been detached from the hydraulic caliper.

FIG. 18 is an outside elevational view of the disc brake caliper illustrated in FIGS. 7 to 16 but in which the mechanical caliper has been detached from the hydraulic caliper.

FIG. 19 is an inside perspective view of the disc brake caliper illustrated in FIGS. 7 to 16 but in which the mechanical caliper has been detached from the hydraulic caliper.

FIG. 20 is an inside elevational view of the disc brake caliper illustrated in FIGS. 7 to 16 but in which the mechanical caliper has been detached from the hydraulic caliper.

FIG. 21 is an outside perspective view of the hydraulic caliper of the disc brake caliper illustrated in FIGS. 7 to 16 where the mechanical caliper has been removed.

FIG. 22 is a transverse cross sectional view of the hydraulic caliper illustrated in FIGS. 17 to 21 as seen along section line 22-22 of FIG. 18.

FIG. 23 is a transverse cross sectional view of the mechanical caliper illustrated in FIGS. 17 to 20 as seen along section line 23-23 of FIG. 18.

FIG. 24 is a partially exploded perspective view of the mechanical caliper illustrated in FIGS. 17 to 20.

FIG. 25 is a partially exploded perspective view of selected internal parts of the mechanical caliper illustrated in FIGS. 17 to 20.

FIG. 26 is a partially exploded perspective view of selected internal parts of the mechanical caliper illustrated in FIGS. 17 to 20.

FIG. 27 is a first perspective view of the mechanical caliper illustrated in FIGS. 17 to 20 in which the housing has been broken away to show the internal parts of the mechanical caliper.

FIG. 28 is a second perspective view of the mechanical caliper illustrated in FIGS. 17 to 20 in which the housing has been broken away to show the internal parts of the mechanical caliper.

FIG. 29 is a diagrammatic view of the internal parts of the mechanical caliper illustrated in FIGS. 27 and 28 in a rest or non-braking position.

FIG. 30 is a diagrammatic view of the internal parts of the mechanical caliper illustrated in FIGS. 27 and 28 in a braking position.

FIG. 31 is an outside elevational view of a disc brake caliper in accordance with a second embodiment in which a lid of the disc brake caliper has been removed from the caliper housing and in which the mechanical caliper is in a non-braking state.

FIG. 32 is an outside elevational view, similar to FIG. 31, of the disc brake caliper in accordance with the second embodiment but in which the mechanical caliper is in a braking state.

FIG. 33 is an outside elevational view of a disc brake caliper in accordance with a third embodiment in which a lid of the disc brake caliper has been removed from the caliper housing and in which the mechanical caliper is in a non-braking state.

FIG. 34 is an outside elevational view, similar to FIG. 33, of the disc brake caliper in accordance with the third embodiment but in which the mechanical caliper is in a braking state.

FIG. 35 is an outside perspective view of a disc brake caliper in accordance with a fourth embodiment.

FIG. 36 is an inside perspective view of the disc brake caliper illustrated in FIG. 35.

FIG. 37 is an outside elevational view of the disc brake caliper illustrated in FIGS. 35 and 36.

FIG. 38 is an inside elevational view of the disc brake caliper illustrated in FIGS. 35 to 37.

FIG. 39 is a top view of the disc brake caliper illustrated in FIGS. 35 to 38.

FIG. 40 is a bottom view of the disc brake caliper illustrated in FIGS. 35 to 39.

FIG. 41 is a top oblique view of the disc brake caliper illustrated in FIGS. 35 to 40 as viewed in a direction parallel to the fastening axes of the frame fasteners.

FIG. 42 is a rear oblique view of the disc brake caliper illustrated in FIGS. 35 to 41.

FIG. 43 is an outside elevational view of the disc brake caliper illustrated in FIGS. 35 to 42 in which a lid of the disc brake caliper has been removed from the caliper housing and in which the mechanical caliper is in a non-braking state.

FIG. 44 is an outside elevational view of the disc brake caliper illustrated in FIGS. 35 to 42 but in which the mechanical caliper is in a braking state.

FIG. 45 is an outside perspective view of the disc brake caliper illustrated in FIGS. 35 to 42 but in which the mechanical caliper has been detached from the hydraulic caliper.

FIG. 46 is an outside elevational view of the disc brake caliper illustrated in FIGS. 35 to 42 but in which the mechanical caliper has been detached from the hydraulic caliper.

FIG. 47 is an inside perspective view of the disc brake caliper illustrated in FIGS. 35 to 42 but in which the mechanical caliper has been detached from the hydraulic caliper.

FIG. 48 is an inside elevational view of the disc brake caliper illustrated in FIGS. 35 to 42 but in which the mechanical caliper has been detached from the hydraulic caliper.

FIG. 49 is an outside perspective view of the hydraulic caliper of the disc brake caliper illustrated in FIGS. 35 to 42 where the mechanical caliper has been removed.

FIG. 50 is a transverse cross sectional view of the hydraulic caliper illustrated in FIG. 48 as seen along section line 50-50 of FIG. 46.

FIG. 51 is an exploded perspective view of the mechanical caliper of the disc brake caliper illustrated in FIGS. 35 to 42.

FIG. 52 is a top oblique view of the mechanical caliper of the disc brake caliper illustrated in FIGS. 35 to 42 in which a lid of the disc brake caliper has been removed from the caliper housing and in which the mechanical caliper is in a non-braking state.

FIG. 53 is a top oblique view of the mechanical caliper of the disc brake caliper illustrated in FIGS. 35 to 42 but in which the mechanical caliper is in a braking state.

FIG. 54 is a rear oblique view of the mechanical caliper of the disc brake caliper illustrated in FIGS. 35 to 42 in which the housing of the mechanical caliper is shown in broken lines to show the internal parts in the non-braking state.

FIG. 55 is a bottom oblique view of the mechanical caliper of the disc brake caliper illustrated in FIGS. 35 to 42 in which the housing of the mechanical caliper is shown in broken lines to show the internal parts in the non-braking state.

FIG. 56 is an outside elevational view of a disc brake caliper in accordance with a fifth embodiment in which a lid of the disc brake caliper has been removed from the caliper housing and in which the mechanical caliper is in a non-braking state.

FIG. 57 is an outside elevational view, similar to FIG. 56, of the disc brake caliper in accordance with the fifth embodiment but in which the mechanical caliper is in a braking state.

FIG. 58 is an outside elevational view of a disc brake caliper in accordance with a sixth embodiment in which a lid of the disc brake caliper has been removed from the caliper housing and in which the mechanical caliper is in a non-braking state.

FIG. 59 is an outside elevational view, similar to FIG. 58, of the disc brake caliper in accordance with the sixth embodiment but in which the mechanical caliper is in a braking state.

FIG. 60 is an exploded perspective view of a mechanical caliper in accordance with a seventh embodiment.

### DETAILED DESCRIPTION

Selected embodiments will now be explained with reference to the drawings. It will be apparent to those skilled in the human-powered vehicle field (e.g., the bicycle field) from this disclosure that the following descriptions of the embodiments are provided for illustration only and not for the purpose of limiting the invention as defined by the appended claims and their equivalents.

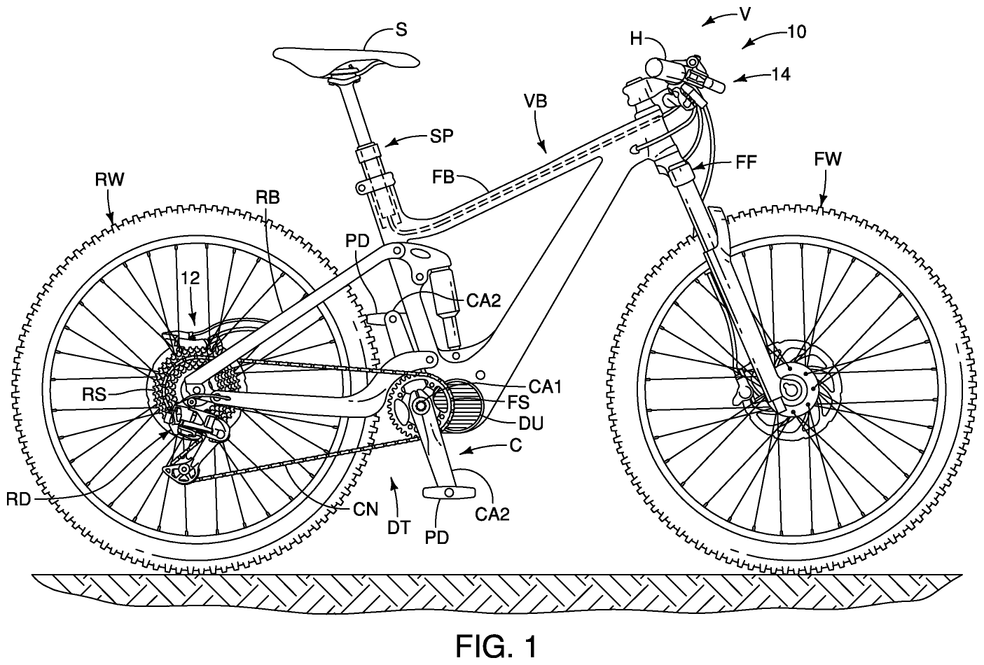

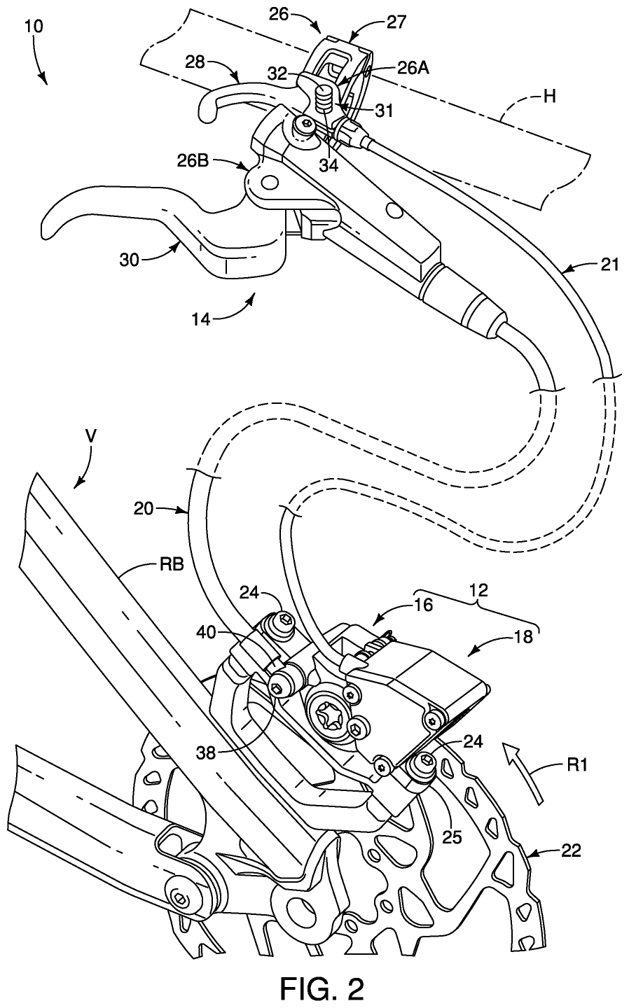

Referring initially to FIGS. 1 and 2, a human-powered vehicle V (e.g., a bicycle) is illustrated that is equipped with a braking system 10 (e.g., a bicycle braking system) in accordance with a first embodiment. Here, the human-powered vehicle V is illustrated as an electric assist bike. However, the braking system 10 can be applied to other types of human-powered vehicles such as, for example, a scooter, an elliptical bike, a tricycle, a mountain bike, a cyclocross bicycle, a road bicycle, a city bike, a cargo bike, and a recumbent bike.

As shown in FIG. 1, the human-powered vehicle V includes a vehicle body VB (e.g., a frame such as a bicycle frame) that is supported by a rear wheel RW and a front wheel FW. The vehicle body VB basically includes a front frame body FB and a rear frame body RB (a swing arm). The vehicle body VB is also provided with a front fork FF and a handlebar H for steering the human-powered vehicle V. The human-powered vehicle V further includes a seatpost SP coupled to the seat tube of the vehicle body VB for supporting a bicycle seat S at the upper end.

The bicycle B further includes a drivetrain DT. Here, for example, the drivetrain DT is a chain-drive type that includes a crank C, at least one front sprocket FS, a plurality of rear sprockets RS and a chain CN. The crank C includes a crank axle CA1 and a pair of crank arms CA2. The crank axle CA1 is rotatably supported to the front frame body FB. The crank arms CA2 are provided on opposite ends of the crank axle CA1. A pair of pedals PD are rotatably coupled to the distal end of each of the crank arms CA2. The front sprocket FS is provided on the crank C to rotate integrally with the crank axle CA1. The rear sprockets RS are provided on a hub of the rear wheel RW. The chain CN runs around the front sprocket FS and the rear sprockets RS. A human driving force is applied to the pedals PD by a rider of the bicycle B such that the driving force is transmitted via the front sprocket FS, the chain CN and the rear sprockets RS to the rear wheel RW. While the drivetrain DT is illustrated as a chain-drive type of drivetrain, the drivetrain DT can be selected from any type of drivetrain, and can be a belt-drive type or a shaft-drive type. Here, the bicycle B further includes a drive unit DU that is configured to apply a propulsion force to the crank axle CA1 of the human-powered vehicle V.

Referring initially to FIG. 2, a portion of the human-powered vehicle V is illustrated having the braking system 10. Here, the disc brake system 10 includes a disc brake caliper 12 and a brake operating (actuating) device 14 in accordance with the first embodiment. The disc brake caliper 12 is provided for a human-powered vehicle V. Basically, the disc brake caliper 12 comprises a hydraulic caliper body 16. Here, the disc brake caliper 12 comprises a mechanical caliper body 18. The hydraulic caliper body 16 is configured to be operated by a hydraulic fluid. In particular, a hydraulic hose 20 is operatively coupled between the brake operating device 14 and the hydraulic caliper body 16. On the other hand, the mechanical caliper body 18 is configured to be operated by a cable 21. In particular, the cable 21 is operatively coupled between the brake operating device 14 and the mechanical caliper body 18. The disc brake caliper 12 is constructed for selectively gripping (slowing and/or stopping rotation) of a disc brake rotor 22 that is fixedly attached to a hub of the wheel RW (e.g., a bicycle wheel). As explained below, typically, the hydraulic caliper body 16 and the mechanical caliper body 18 are selectively used to grip (slow or stop rotation) of a disc brake rotor 22. A user can individually operate the hydraulic caliper body 16 and the mechanical caliper body 18 using the brake operating device 14. More specifically, the hydraulic caliper body 16 is typically used during riding to slow or stop rotation of the wheel RW, while the mechanical caliper body 18 is typically used when the human-powered vehicle V is parked to keep the wheel RW from rotating. Thus, here, the mechanical caliper body 18 constitutes a parking brake of the human-powered vehicle V.

Here, as seen in FIG. 2, the disc brake caliper 12 is mounted to the vehicle body VB (e.g., a frame such as a bicycle frame) of the human-powered vehicle V by a bracket 23 using a pair of fixing bolts 24 (i.e., frame fasteners). In particular, the hydraulic caliper body 16 includes a coupling portion 25. The coupling portion 25 is configured to couple the hydraulic caliper body 16 to the vehicle body VB of the human-powered vehicle V. Here, for example, the coupling portion 25 includes a first coupling hole 25A and a second coupling hole 25B. The first coupling hole 25A and the second coupling hole 25B are through holes for receiving the fixing bolts 24 therethrough. The first coupling hole 25A and the second coupling hole 25B are preferably elongated holes to allow for some adjustment of the hydraulic caliper body 16 relative to the vehicle body VB. The mechanical caliper body 18 is configured to be coupled to the vehicle body VB by the coupling portion 25 of the hydraulic caliper body 16. In other words, the mechanical caliper body 18 is not directed attached to the vehicle body VB. Rather, the mechanical caliper body 18 is supported to the vehicle body VB by the hydraulic caliper body 16. Here, the mechanical caliper body 18 is positioned on an upstream side of the hydraulic caliper body 16 relative to a rotational direction R1 of the rotor 22.

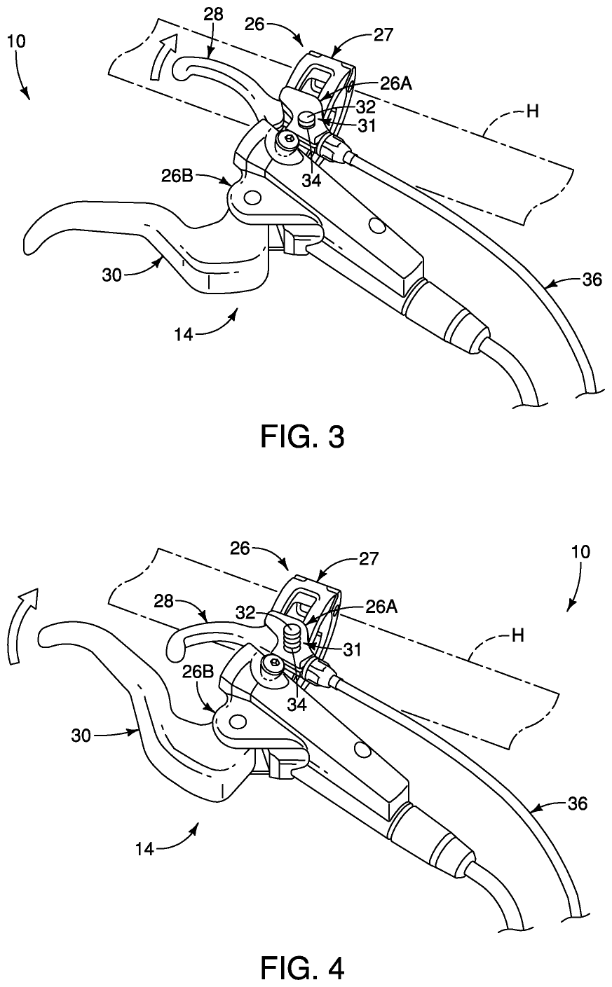

As seen in FIGS. 2 to 4, basically, the brake operating device 14 is designed to actuate the disc brake caliper 12 in a conventional manner to apply a forcible gripping action on the disc brake rotor 22 to stop rotation of the wheel RW. Here, in the first embodiment, the brake operating device 14 basically includes a base member 26 having a handlebar clamp 27, a first brake lever 28 and a second brake lever 30. The first brake lever 28 is pivotally mounted to the base member 26 between a rest or non-operated position (FIG. 2) and an actuated or operated position (FIG. 3). The first brake lever 28 is spring biased towards the rest position, which corresponds to a non-braking or brake release position by a first return spring. Similarly, the second brake lever 30 is pivotally mounted to the base member 26 between a rest or non-operated position (FIG. 2) and an actuated or operated position (FIG. 4). The second brake lever 30 is also spring biased towards the rest position, which corresponds to a non-braking or brake release position by a second return spring.

In the first embodiment, as seen in FIGS. 2 to 4, the brake operating device 14 is mounted to the handlebar H (i.e., a part of the human-powered vehicle V, namely a part of the bicycle body). However, the brake operating device 14 can be mounted to other parts of the human-powered vehicle V as needed and/or desired. Here, in the illustrated embodiment, the brake operating device 14 is coupled to the human-powered vehicle V by the handlebar clamp 27, which is one example of a fixing structure. Here, the handlebar clamp 27 is a hinged tube clamp. Since hinged tube clamps are well known, the handlebar clamp 27 (i.e., the fixing structure) will not be discussed and/or illustrated in detail. The handlebar clamp 27 (i.e., the fixing structure) can also be referred to as a handlebar mounting structure in the case of the illustrated embodiment.

Here, the base member 26 includes a first base part 26A and a second base part 26B. Here, the second base part 26B is fixedly mounted to the handlebar clamp 27, and the first base part 26A is detachably mounted to the second base part 26B. In this way, the first base part 26A and the first brake lever 28 can be removed from the second base part 26B. Alternatively, the first base part 26A and the second base part 26B can be mounted to separate fixing structures. In this way, the first brake lever 28 can be mounted to the handlebar H at a location spaced apart from the second base part 26B, or some other location on the vehicle body VB.

Here, the first brake lever 28 is a parking brake lever, while the second brake lever 30 is used during riding. In other words, the first brake lever 28 is configured to be operated by a user such that the first brake lever 28 can be locked in the operated position (FIG. 3) to maintain the disc brake caliper 12 in a braking state even after the first brake lever 28 is released by the user. Here, the brake operating device 14 is provided with a locking device 31 to lock the first brake lever 28 in the operated position. On the other hand, the second brake lever 30 is configured to be operated by a user to temporarily hold the disc brake caliper 12 in the braking state while the second brake lever 30 is held by the user in the operated state. Once the user releases the second brake lever 30, the second brake lever 30 is automatically moved to the rest position (i.e., the non-braking position).

Referring to FIGS. 3 and 4, the locking device 31 includes a locking member 32 that is movable between an unlocked position and a locked position. When the locking member 32 is in the unlocked position as seen in FIG. 2, the first brake lever 28 is in the rest position (i.e., the non-operated position or non-braking position). When the locking member 32 is in the locked position as seen in FIG. 3, the first brake lever 28 is in the operated position (i.e., the braking position). Preferably, the locking device 31 includes a biasing member 34 that biases the locking member 32 towards the unlocked position. Thus, when the first brake lever 28 is moved from the rest position (FIG. 2) to the braking position (FIG. 3), the locking member 32 is moved by the user to the locked position to block movement of the first brake lever 28 back towards the rest position. For example, the biasing member 34 is a coiled compression spring that is positioned around the locking member 32 to bias the locking member 32 towards the unlocked position. In the locked position, the locking member 32 has an abutment that contacts the first brake lever 28 to prevent the first brake lever 28 from moving to the rest position. More specifically, the abutment of the locking member 32 is squeezed between the first brake lever 28 and the base member 26 by the first return spring of the first brake lever 28. The first brake lever 28 can be released to move towards the rest position by operating the first brake lever 28 to release the pressure applied to the locking member 32 such that the biasing force of the biasing member 34 moves the locking member 32 to the unlocked position.

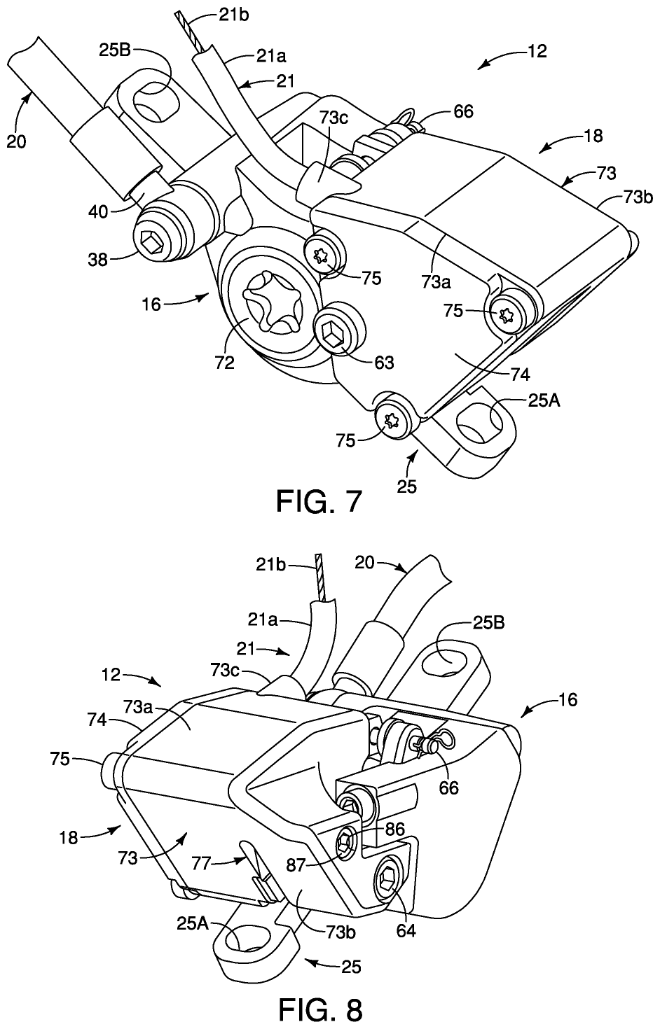

As mentioned above and as seen in FIG. 2, the first brake lever 28 is operatively coupled to the mechanical caliper body 18 by the cable 21. Basically, as seen in FIGS. 7 and 8, the cable 21 has an outer casing 21a and an inner wire 21b. Optionally, a barrel adjuster can be provided between the mechanical caliper body 18 and the outer casing 21a of the cable 21 for adjusting cable tension. The outer casing 21a extends between a portion of the base member 26 and a portion of the mechanical caliper body 18. The inner wire 21b is fixedly coupled to the first brake lever 28 and a portion of the mechanical caliper body 18 as discussed below.

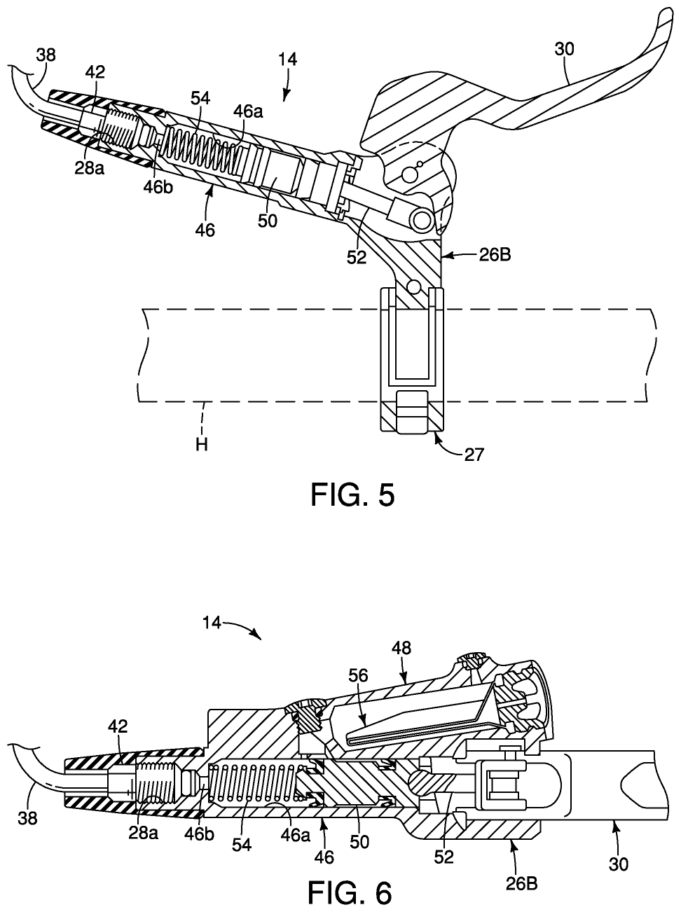

As seen in FIG. 2, the second brake lever 30 is operatively coupled to the hydraulic caliper body 16 by the hydraulic hose 20. In particular, the hydraulic caliper body 16 comprises a hydraulic hose connector 38. Here, the hydraulic hose connector 38 includes a banjo bolt. The hydraulic hose 20 includes a banjo hose end fitting 40 that is fluidly connected to the hydraulic caliper body 16 by the hydraulic hose connector 38. As seen in FIGS. 5 and 6, the other end of the hydraulic hose 20 is fluidly connected to the base member 26 by a hose fitting 42 that is screwed into a threaded hole of the base member 26.

As seen in FIGS. 5 and 6, the second base part 26B includes a master cylinder 46 and a hydraulic fluid reservoir 48. The brake operating device 14 further comprises a piston 50 movably disposed in a master cylinder bore 46a of the master cylinder 46. The master cylinder 46 also has an outlet port 46b for supplying hydraulic fluid to the hydraulic caliper body 16 via the hydraulic hose 20. More specifically, as the second brake lever 30 is pivoted relative to the second base part 26B from the rest position (FIG. 2) to the operated position (FIG. 4), the piston 50 moves linearly in the master cylinder bore 46a. Thus, the second brake lever 30 is operatively coupled to the piston 50 to pressurize the hydraulic fluid in the master cylinder bore 46a and force the hydraulic fluid through the outlet port 46b into the hydraulic hose 20 towards the hydraulic caliper body 16. Here, the brake operating device 14 further comprises a push or connecting rod 52 that operatively connects the second brake lever 30 to the piston 50. In this way, for example, the second brake lever 30 is coupled to the piston 50 to move the piston 50 within the master cylinder bore 46a. The brake operating device 14 further comprises a biasing element 54 (e.g., a coil compression spring) that biases the piston 50 to its initial (rest or non-operated) position and that also biases the second brake lever 30 to its rest position (i.e., no external force applied to the second brake lever 30) as seen in FIG. 5. Thus, the biasing element 54 functions as a return spring for the second brake lever 30.

The hydraulic fluid reservoir 48 is in fluid communication with the master cylinder bore 46a of the master cylinder 46. The hydraulic fluid reservoir 48 contains hydraulic fluid (mineral oil) that is supplied to the master cylinder bore 46a of the master cylinder 46. Here, the brake operating device 14 further comprises a diaphragm 56 that is disposed in the hydraulic fluid reservoir 48.

As seen in FIGS. 5 and 6, the hydraulic hose 20 has a first end that is fluidly connected to the master cylinder bore 46a of the master cylinder 46 by the hose fitting 42 that is threaded into a threaded bore 28a of the second base part 26B. As seen in FIG. 7, the hydraulic hose 20 has a second end that is fluidly connected to the hydraulic caliper body 16 by the hydraulic hose connector 38. In this way, the brake operating device 14 is fluidly connected to the hydraulic caliper body 16.

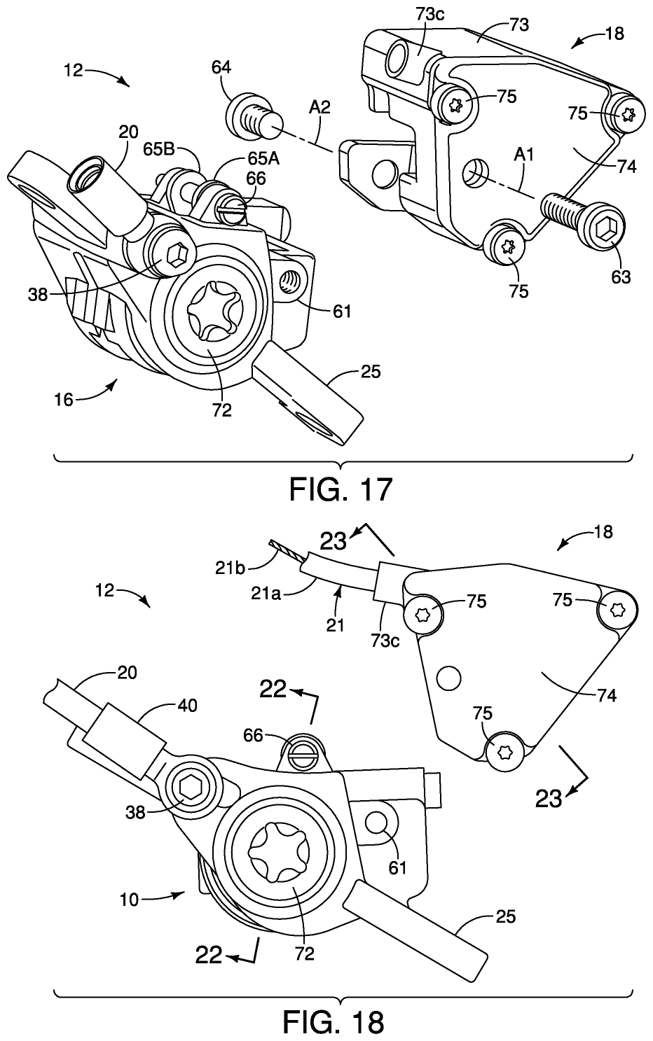

Referring to FIGS. 17 to 20, the hydraulic caliper body 16 includes a first attachment portion 61. Preferably, the hydraulic caliper body 16 further includes a second attachment portion 62. The first attachment portion 61 is provided on an outbound side S1 of the hydraulic caliper body 16 and the second attachment portion 62 is provided on an inbound side S2 of the hydraulic caliper body 16. The first attachment portion 61 is configured to couple the mechanical caliper body 18. Here, the first attachment portion 61 is configured to be attached to the mechanical caliper body 18. Specifically, the first attachment portion 61 is configured to detachably couple the mechanical caliper body 18 thereto. The second attachment portion 62 is configured to be attached to the mechanical caliper body 18. The second attachment portion 62 is offset from the first attachment portion 61. The disc brake caliper 12 further comprises a first fixing member 63 configured to detachably couple the mechanical caliper body 18 to the first attachment portion 61 of the hydraulic caliper body 16. The disc brake caliper 12 further comprises a second fixing member 64 configured to detachably attach the second attachment portion 62 to the mechanical caliper body 18. The first fixing member 63 has a first fixing axis A1 and the second fixing member 64 has a second fixing axis A2 that is parallel to the first fixing axis A1 in a state where the first fixing member 63 and the second fixing member 64 are attached to the hydraulic caliper body 16.

Referring to FIGS. 21 and 22, the disc brake caliper 12 further comprises a first brake pad 65A and a second brake pad 65B. The first brake pad 65A and the second brake pad 65B are movably coupled to the hydraulic caliper body 16 by a connecting pin 66. The hydraulic caliper body 16 has a rotor receiving slot 16a. The first brake pad 65A and the second brake pad 65B are disposed in the rotor receiving slot 16a. In particular, the first brake pad 65A is located on one side of the rotor receiving slot 16a, and the second brake pad 65B is located on the other side of the rotor receiving slot 16a. The disc brake caliper 12 further comprises a biasing element 67 operatively disposed between the first brake pad 65A and the second brake pad 65B to maintain the rotor receiving slot 16a in a state where the second brake lever 30 is in the non-operated position.

As seen in FIG. 22, the disc brake caliper 12 further comprises a first hydraulic piston 68. The first brake pad 65A can be bonded to the first hydraulic piston 68 as needed and/or desired. Alternatively, the first brake pad 65A is maintained in contact with the first hydraulic piston 68 by the biasing element 67. In any case, the biasing element 67 applies a biasing force to the first brake pad 65A and the first hydraulic piston 68 so that the first brake pad 65A and the first hydraulic piston 68 do not contact the rotor 22 where the second brake lever 30 is in the non-operated position. The first hydraulic piston 68 is configured to be operated by a hydraulic fluid. The first hydraulic piston 68 is movably provided in the hydraulic caliper body 16. In particular, the hydraulic caliper body 16 includes a first cylinder 69. The first hydraulic piston 68 is movably provided in the first cylinder 69. The first cylinder 69 is fluidly connected to the hydraulic hose 20 via internal passageways form in the hydraulic caliper body 16. The first hydraulic piston 68 moves the first brake pad 65A into contact with the rotor 22. In other words, upon operation of the second brake lever 30, the first hydraulic piston 68 moves the first brake pad 65A into contact with the rotor 22.

As seen in FIG. 22, the disc brake caliper 12 further comprises a second hydraulic piston 70. The second hydraulic piston 70 is movably provided in a second cylinder 71 of the hydraulic caliper body 16 to move the second brake pad 65B into contact with the rotor 22. The second brake pad 65B can be bonded to the second hydraulic piston 70 as needed and/or desired. Alternatively, the second brake pad 65B is maintained in contact with the second hydraulic piston 70 by the biasing element 67. In any case, the biasing element 67 applies a biasing force to the second brake pad 65B and the second hydraulic piston 70 so that the second brake pad 65B and the second hydraulic piston 70 do not contact the rotor 22 where the second brake lever 30 is in the non-operated position. The second cylinder 71 is fluidly connected to the hydraulic hose 20 via internal passageways form in the hydraulic caliper body 16. Thus, upon operation of the second brake lever 30, the second hydraulic piston 70 moves the second brake pad 65B into contact with the rotor 22. Alternatively, the second hydraulic piston 70 and the second cylinder 71 can be omitted and the second brake pad 65B can be a stationary brake pad that is bonded to the hydraulic caliper body 16.

Here, the first hydraulic piston 68 and the second hydraulic piston 70 are hydraulically operated pistons. Accordingly, the first hydraulic piston 68 and the second hydraulic piston 70 are movably mounted to the hydraulic caliper body 16 such that the first hydraulic piston 68 and the second hydraulic piston 70 move the first brake pad 65A and the second brake pad 65B. In particular, the first hydraulic piston 68 and the second hydraulic piston 70 are configured to move relative to the hydraulic caliper body 16 in response to operation of the second brake lever 30. Thus, the first hydraulic piston 68 and the second hydraulic piston 70 are configured to move the first brake pad 65A and the second brake pad 65B to contact the disc brake rotor 22 in response to the second brake lever 30 being operated from the rest position (i.e., the non-braking position) to the operated position (i.e., the braking position). In other words, when the second brake lever 30 is operated by a user, the first hydraulic piston 68 and the second hydraulic piston 70 are moved relative to the hydraulic caliper body 16 to move the first brake pad 65A and the second brake pad 65B into contact with the disc brake rotor 22. Thus, the first brake pad 65A and the second brake pad 65B contact the disc brake rotor 22 to apply a braking force to the disc brake rotor 22 in response to operation of the second brake lever 30.

Here, the hydraulic caliper body 16 is a one-piece member. The hydraulic caliper body 16 is preferably constructed of a hard, rigid material, such as a metallic material. Of course, other suitable materials can be utilized as needed and/or desired. The disc brake caliper 12 further comprises a cylinder plug 72 that is threaded to the hydraulic caliper body 16. The cylinder plug 72 closes off one end of the first cylinder 69. The cylinder plug 72 is installed prior to installing the first hydraulic piston 68 in the first cylinder 69.

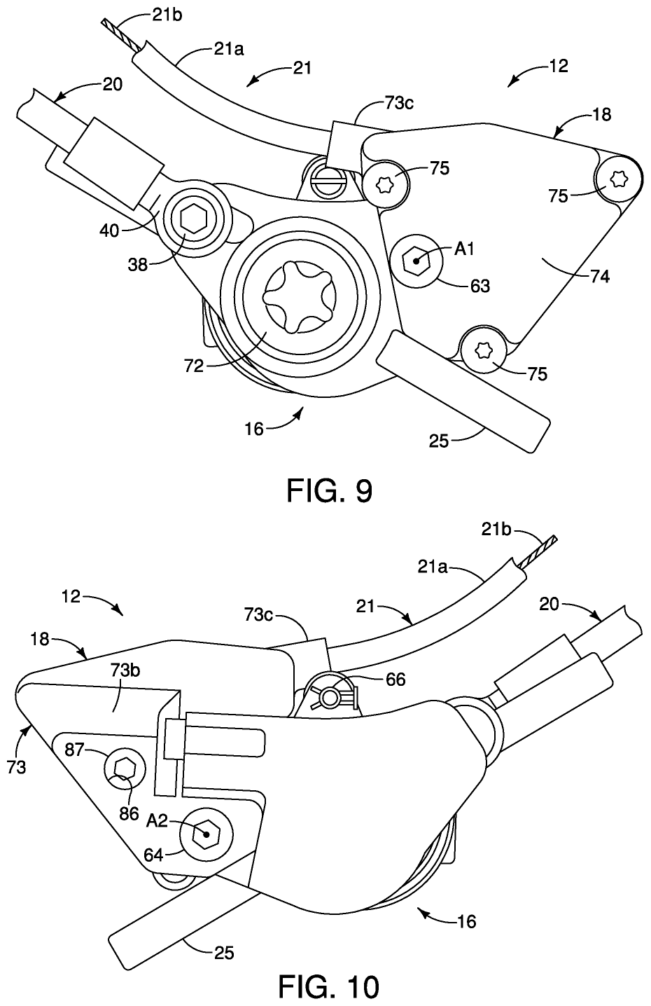

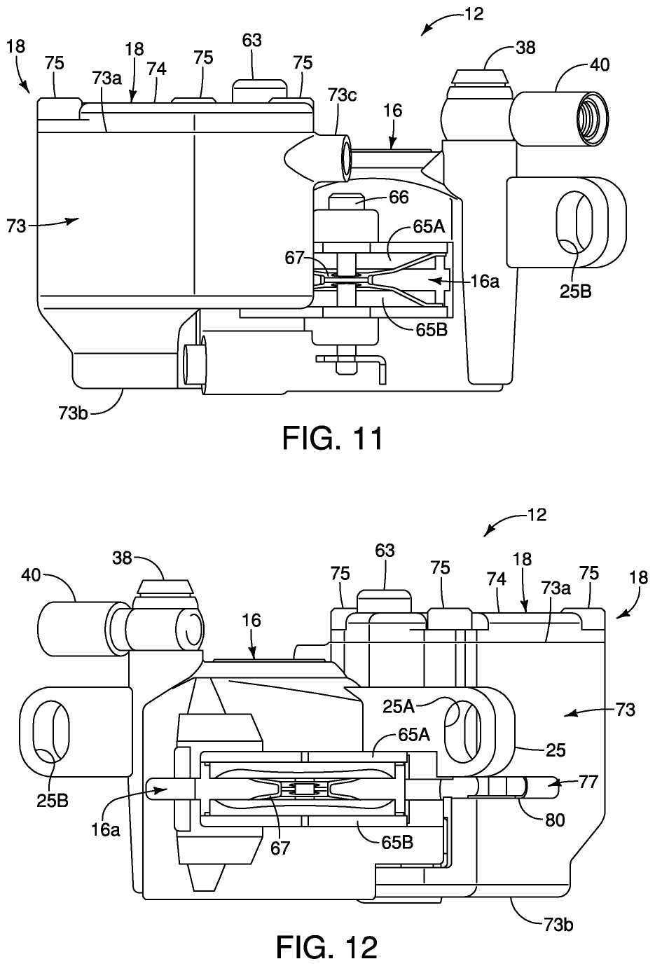

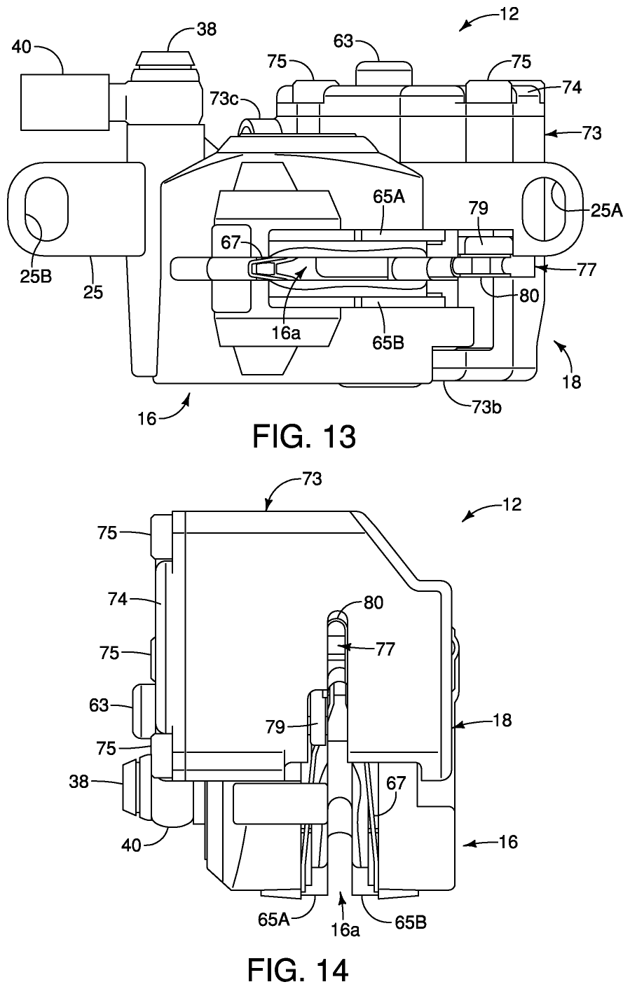

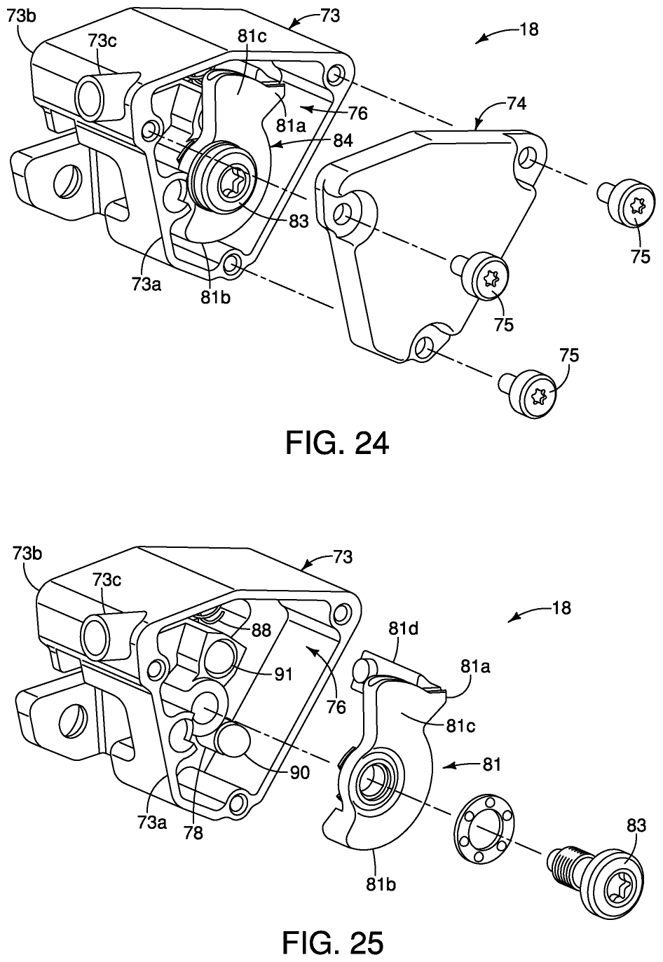

Referring to FIGS. 7 to 9 and 24, the mechanical caliper body 18 includes a caliper housing 73. The mechanical caliper body 18 further includes a lid 74 detachably coupled to the caliper housing 73. Here, the lid 74 is detachably coupled to the caliper housing 73 by at least one fastener 75 (e.g., threaded fasteners such as bolts). The lid 74 is detachably coupled to the caliper housing 73 by three fasteners. The caliper housing 73 has an interior space 76. The lid 74 is removed from the caliper housing 73 to access the interior space 76. The lid 74 is attached to the caliper housing 73 to close off access the interior space 76.

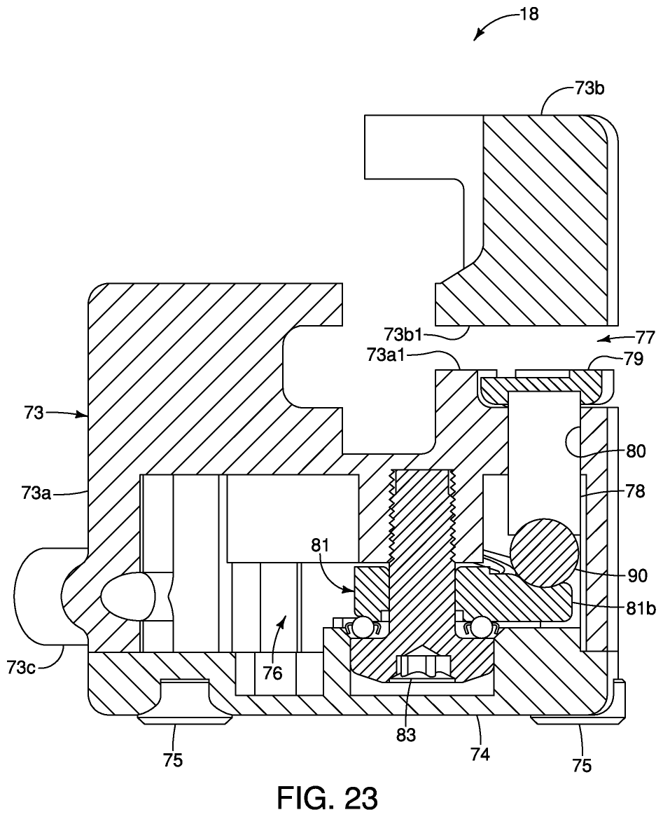

Referring to FIG. 23, the caliper housing 73 defines a rotor receiving slot 77. The caliper housing 73 includes an outbound portion 73a having a first inner surface 73a1 defining a first side of the rotor receiving slot 77, and an inbound portion 73b having a second inner surface 73b1 defining a second side of the rotor receiving slot 77. The caliper housing 73 has a cable port 73c provided on the outbound portion 73a. The cable port 73c is configured to abut the outer casing 21a of the cable 21 and to allow the inner wire 21b of the cable 21 to pass therethrough. The cable port 73c can be threaded to receive a cable adjuster as needed and/or desired.

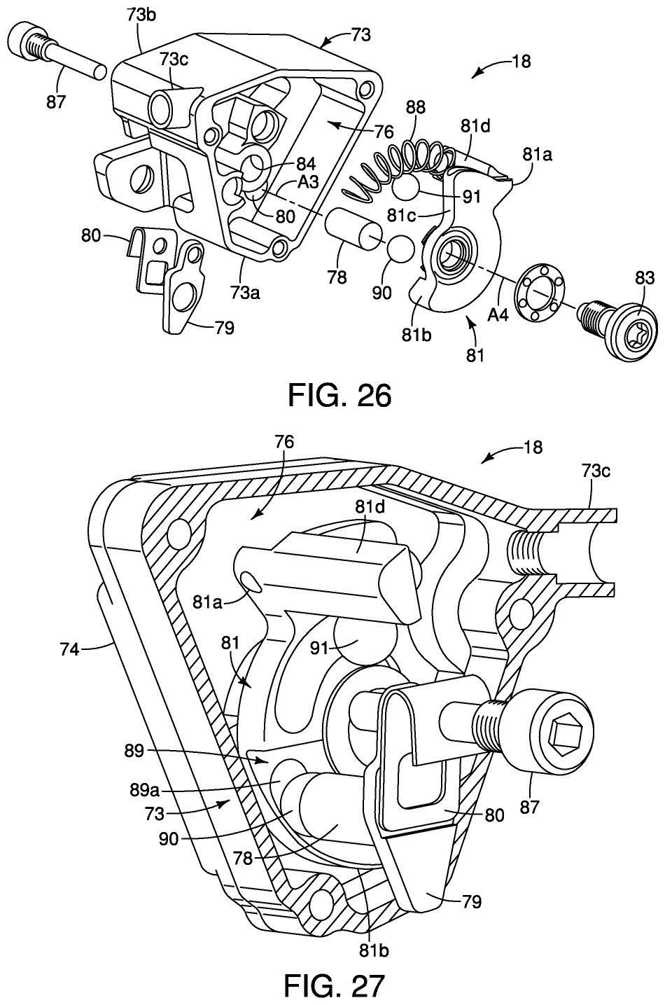

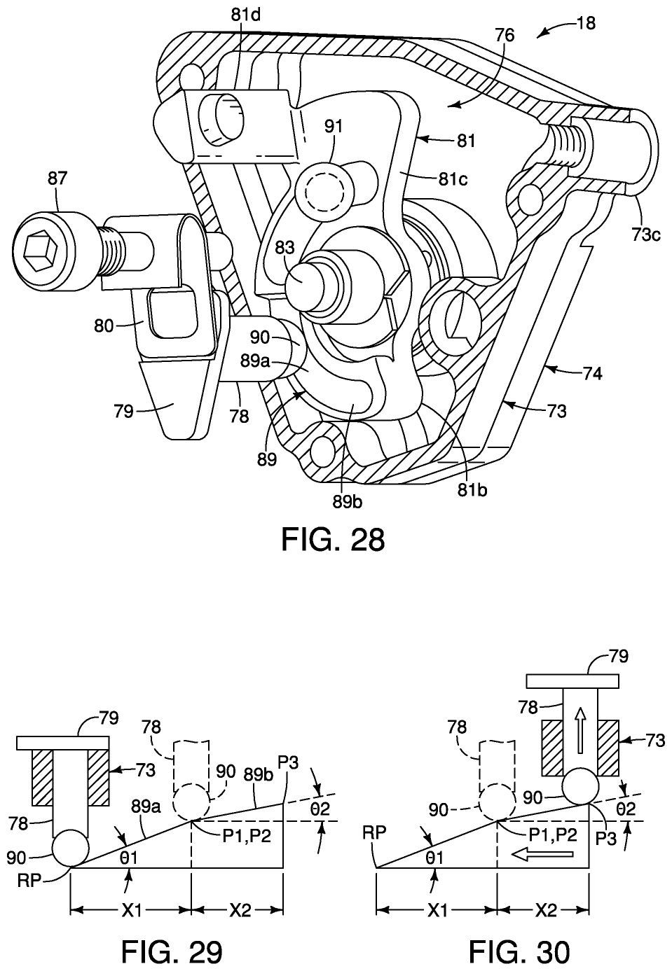

Referring to FIGS. 23 and 25 to 28, the disc brake caliper 12 comprises a mechanical piston 78. The mechanical piston 78 is movably provided in the mechanical caliper body 18. Here, the outbound portion 73a has a piston bore 80. The mechanical piston 78 is slidably disposed in the piston bore 80. The mechanical piston 78 is configured to move along a mechanical piston axis A3. Basically, the mechanical piston 78 is configured to move a brake pad into contact with the rotor 22. In particular, the mechanical piston 78 is configured to move an auxiliary brake pad 79 into contact with the rotor 22. The disc brake caliper 12 further comprises a mechanical piston biasing element 80 configured to bias the mechanical piston 78 towards a non-actuated position.

Referring to FIGS. 23 to 28, the disc brake caliper 12 comprises an intermediate member 81. The mechanical caliper body 18 entirely covers the intermediate member 81 and covers a majority of the mechanical piston 78. In particular, the intermediate member 81 is disposed in the interior space 76. The intermediate member 81 is movably provided in the mechanical caliper body 18. Here, the intermediate member 81 has a cable attachment portion 81a configured to be coupled to the cable 21. The intermediate member 81 is configured to move the mechanical piston 78 in response to movement of the cable 21 during a braking operation. In particular, the intermediate member 81 further includes a cam portion 81b configured to move the mechanical piston 78.

The intermediate member 81 is configured to pivot about a pivot axis A4. Specifically, the intermediate member 81 is pivotally provided in the mechanical caliper body 18 about the pivot axis A4. More specifically, the intermediate member 81 is pivotally supported to the outbound portion 73a by a first shaft 83. The outbound portion 73a has a first shaft support recess 84 receiving the first shaft 83. Here, the first shaft 83 is formed by a bolt that is screwed into the first shaft support recess 84. In this way, the intermediate member 81 is pivotally supported to the outbound portion 73a by the first shaft 83. The pivot axis A4 is different from the mechanical piston axis A3. The pivot axis A4 is offset from the mechanical piston axis A3. Here, in the first embodiment, the pivot axis A4 is parallel to the mechanical piston axis A3.

The cable attachment portion 81a is spaced radially outward from the pivot axis A4. Here, the intermediate member 81 further includes an actuating arm 81c extending radially from the first shaft 83 with respect to a pivot axis A4 of the first shaft 83. The actuating arm 81c includes the cable attachment portion 81a at a position spaced from the pivot axis A4. The cable attachment portion 81a and the cam portion 81b are a one-piece member. Preferably, the cable attachment portion 81a, the cam portion 81b and the actuating arm 81c are a one-piece member. Thus, the cable attachment portion 81a, the cam portion 81b and the actuating arm 81c are integrally formed as a part of the intermediate member 81. The cable attachment portion 81a includes a groove configured to catch the inner wire 21b of the cable 21 and a receiver configured to hold a barrel shaped nipple 21c of the cable 21.

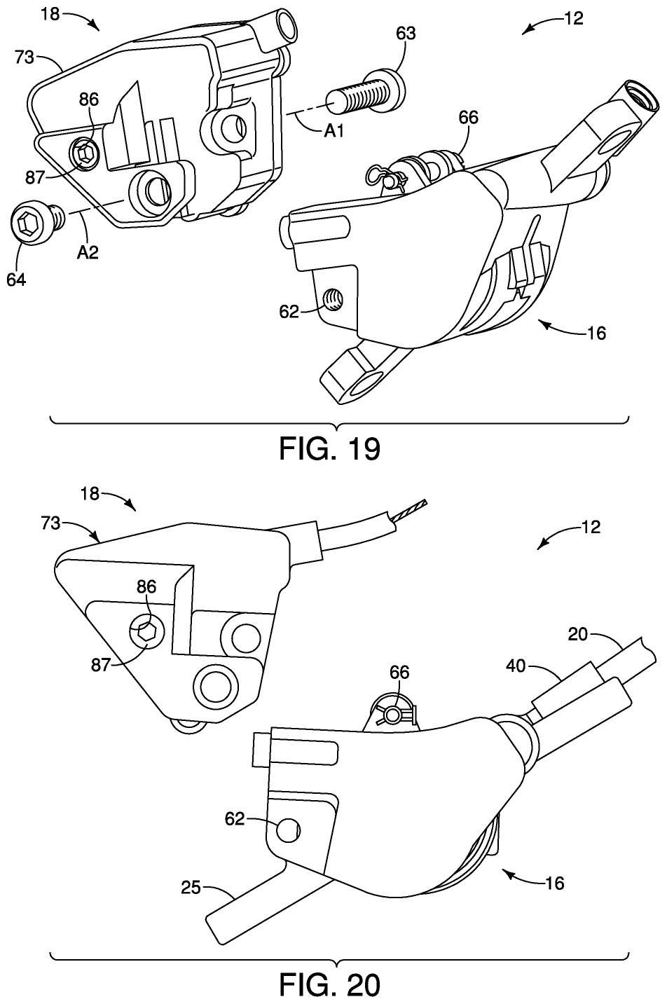

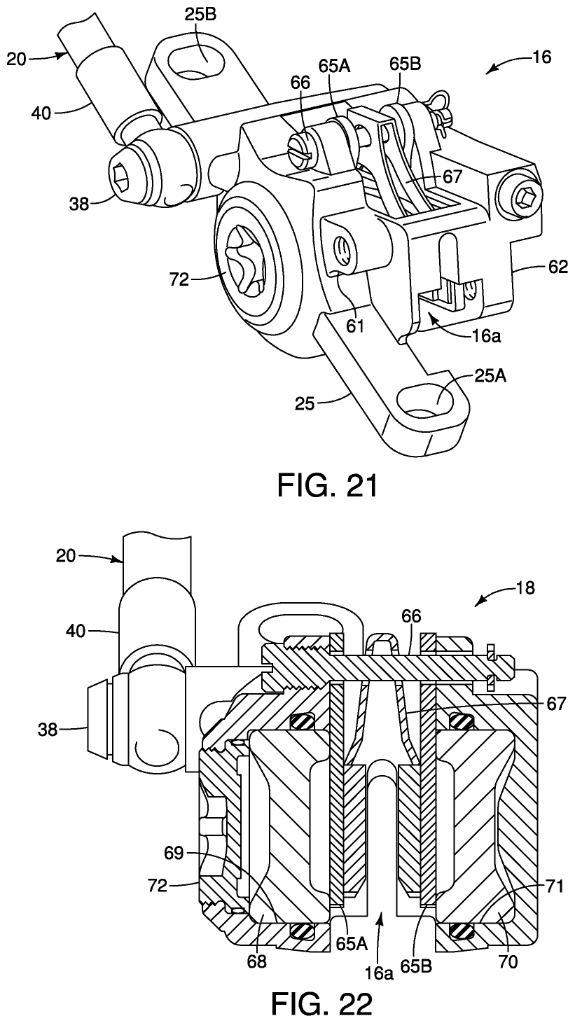

Referring back to FIGS. 19 to 20, the caliper housing 73 includes a second shaft support recess 86. The second shaft support recess 86 is configured to receive a brake pad shaft 87. The brake pad shaft 87 movably supports the auxiliary brake pad 79 with respect to the caliper housing 73. Here, the brake pad shaft 87 supports the mechanical piston biasing element 80 to the caliper housing 73.

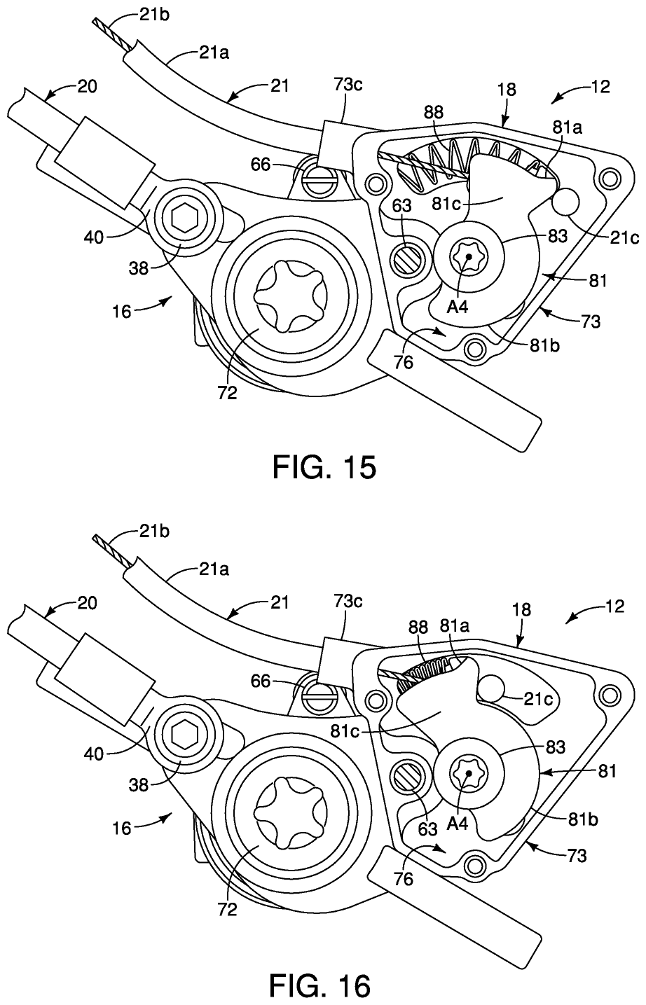

Referring back to FIGS. 15, 16 and 26, the disc brake caliper 12 further comprises a biasing element 88. The biasing element 88 is configured to bias the intermediate member 81 to a non-actuated position. Here, the biasing element 88 is disposed between the caliper housing 73 and the intermediate member 81. In particular, the intermediate member 381 includes an abutment portion 81d for abutting against one end of the biasing element 88. The other end of the biasing element 88 abuts against an inner surface of the caliper housing 73. In the illustrated embodiment, for example, the biasing element 88 is a coiled compression spring that is compressed during a braking operation. Thus, the biasing element 88 acts as a return spring to return intermediate member 81 to the non-actuated position.

Referring to FIGS. 27 to 30, the cam portion 81b of the intermediate member 81 includes a cam surface 89. The cam surface 89 is configured to contact and move the mechanical piston 78 along the mechanical piston axis A3 as the intermediate member 81 pivots about the pivot axis A4 in response to movement of the cable 21 during a braking operation. Preferably, as in the first embodiment, the intermediate member 81 is configured to produce a variable rate of travel of the mechanical piston 78 relative to a travel of the cable 21 as the intermediate member 81 moves relative to the mechanical caliper body 18. Alternatively, the intermediate member 81 can be configured to produce a constant rate of travel of the mechanical piston 78 relative to a travel of the cable 21 as the intermediate member 81 moves relative to the mechanical caliper body 18. In the first embodiment, the cam surface 89 is configured to produce a variable rate of travel of the mechanical piston 78 relative to a travel of the cable 21 as the intermediate member 81 moves relative to the mechanical caliper body 18.

The cam surface 89 of the intermediate member 81 has a first cam surface 89a configured to move the mechanical piston 78. The disc brake caliper 12 further comprises a first rolling element 90. The first rolling element 90 is disposed between the mechanical piston 78 and the first cam surface 89a. In the first embodiment, the first cam surface 89a is a curved or arcuate groove and the first rolling element 90 is a ball.

Preferably, as in the first embodiment, the cam surface 89 of the intermediate member 81 has a second cam surface 89b. The second cam surface 89b is configured to move the mechanical piston 78. The disc brake caliper 12 further comprises a second rolling element 91. The second rolling element 91 is disposed between the mechanical caliper body 18 and the second cam surface 89b. In the first embodiment, the second cam surface 89b is a curved or arcuate groove the second rolling element 91 is a ball.

Where the intermediate member 81 has both the first cam surface 89a and second cam surface 89b as in the first embodiment, the first cam surface 89a is configured to move the mechanical piston 78 at a first piston actuation rate, while the second cam surface 89b is configured to move the mechanical piston 78 at a second piston actuation rate. The first piston actuation rate is greater than the second piston actuation rate. Here, in the first embodiment, the first cam surface 89a and the second cam surface 89b are contiguous to form a continuous curved or arcuate groove that is curved about the mechanical piston axis A3. The first cam surface 89a and the second cam surface 89b are inclined with respect to a mechanical piston movement direction D1. Thus, the first cam surface 89a and the second cam surface 89b are ramp-shaped. The first cam surface 89a has a first inclination θ1 and the second cam surface 89b has a second inclination θ2. The first inclination θ1 is different from the second inclination θ2.

With this configuration of the first embodiment, as diagrammatically illustrated in FIGS. 29 and 30, the mechanical piston 78 is configured to be moved by the first cam surface 89a towards the rotor 22 from a rest position RP to a first position P1 as the intermediate member 81 along a first movement range X1 during a braking operation. Thus, during the first movement range X1 of the braking operation, the mechanical piston 78 moves at the first piston actuation rate. The mechanical piston 78 is configured to be moved by the second cam surface 89b further towards the rotor 22 from a second position P2 to a third position P3 as the intermediate member 81 along a second movement range X2 during the braking operation. The second movement range X2 is after the first movement range X1. Thus, during the second movement range X2 of the braking operation, the mechanical piston 78 moves at the second piston actuation rate. Since the first piston actuation rate is greater than the second piston actuation rate, the mechanical piston 78 moves quickly into engagement with the rotor 22 during the first movement range X1 of the braking operation. Then, even though the first brake lever 28 is moved at the same rate of speed, the mechanical piston 78 moves slower as a braking force is applied to the rotor 22 during the second movement range X2 of the braking operation.

Basically, during a braking operation of the mechanical caliper body 18, a user operates the first brake lever 28 to pull the inner wire 21b of the cable 21 with respect to the mechanical caliper body 18. The pulling of the inner wire 21b of the cable 21 rotates the intermediate member 81 about the pivot axis A4. The rotation of the intermediate member 81 causes the cam portion 81b to move the mechanical piston 78 linearly along the mechanical piston axis A3. The linear movement of the mechanical piston 78 cause the auxiliary brake pad 79 to engage the rotor 22 to apply a braking force to the rotor 22.

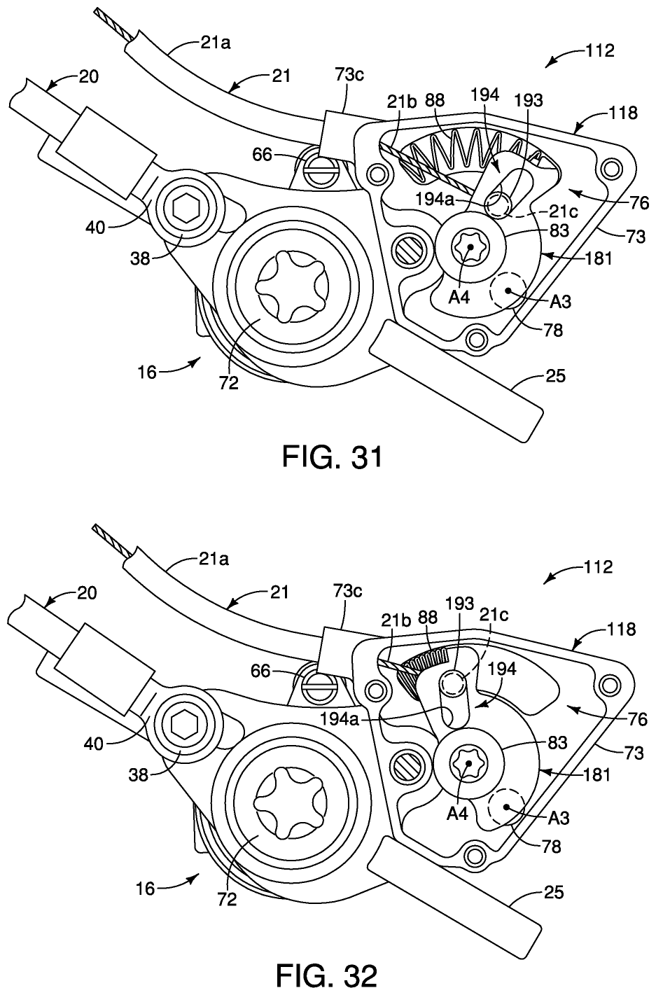

Referring now to FIGS. 31 and 32, a disc brake caliper 112 is illustrated in accordance with a second embodiment. The disc brake caliper 112 includes the hydraulic caliper body 16 of the first embodiment and a modified mechanical caliper body 118. In view of the similarity between the disc brake caliper 12 of the first embodiment and the disc brake caliper 112 of the second embodiment, the parts of the second embodiment that are identical to the parts of the first embodiment will be given the same reference numerals as the parts of the first embodiment. Moreover, the descriptions of the parts of the second embodiment that are identical to the parts of the first embodiment may be omitted for the sake of brevity.

Here, the disc brake caliper 112 is identical to the disc brake caliper 12 of the first embodiment, except that the intermediate member 81 of the disc brake caliper 12 has been replaced with an intermediate member 181 in the disc brake caliper 112 of the second embodiment. Specifically, the disc brake caliper 112 further comprises a cable attachment part 193 configured to be attached to the cable 21. The intermediate member 181 includes a part 194 coupled to the cable attachment part 193 to produce the variable rate of travel of the mechanical piston 78. Basically, the cable attachment part 193 is configured to at least partly move relative to the pivot axis A4 as the intermediate member 181 pivots about the pivot axis A4. The part 194 includes a contact surface 194a. The contact surface 194a is configured to slidably contact the cable attachment part 193 to produce the variable rate of travel of the mechanical piston 78. More specifically, in the second embodiment, the cable attachment part 193 includes a cable retainer configured to retain the barrel shaped nipple 21c of the cable 21, and the contact surface 194a is formed by a slot that slidably receives the cable retainer (i.e., the cable attachment part 193). The cable retainer has a cylindrical shape. The cable retainer includes a container space configured to hold the barrel shaped nipple 21c and an attachment through hole configured to allow the inner wire 21b of the cable 21 to pass therethrough. The cable attachment part 193 can include the barrel shaped nipple 21c of the cable 21, and the contact surface 194a can be formed by a slot that slidably receives the barrel shaped nipple 21c of the cable 21. The contact surface 194a (e.g., the slot) is orientated relative to the pivot axis A4 of the intermediate member 181 so that the barrel shaped nipple 21c of the cable 21 moves away from the pivot axis A4 as the intermediate member 181 pivots about the pivot axis A4 during a braking operation. In this way, the cable attachment part 193 is configured to at least partly move away from the pivot axis A4 as the intermediate member 181 pivots about the pivot axis A4 during a braking operation. As a result, the mechanical piston 78 moves at a variable rate of travel relative to a travel of the cable 21 as the intermediate member 181 pivots about the pivot axis A4 during a braking operation. With this embodiment, the cam surface of the intermediate member 181 can have a constant inclination.

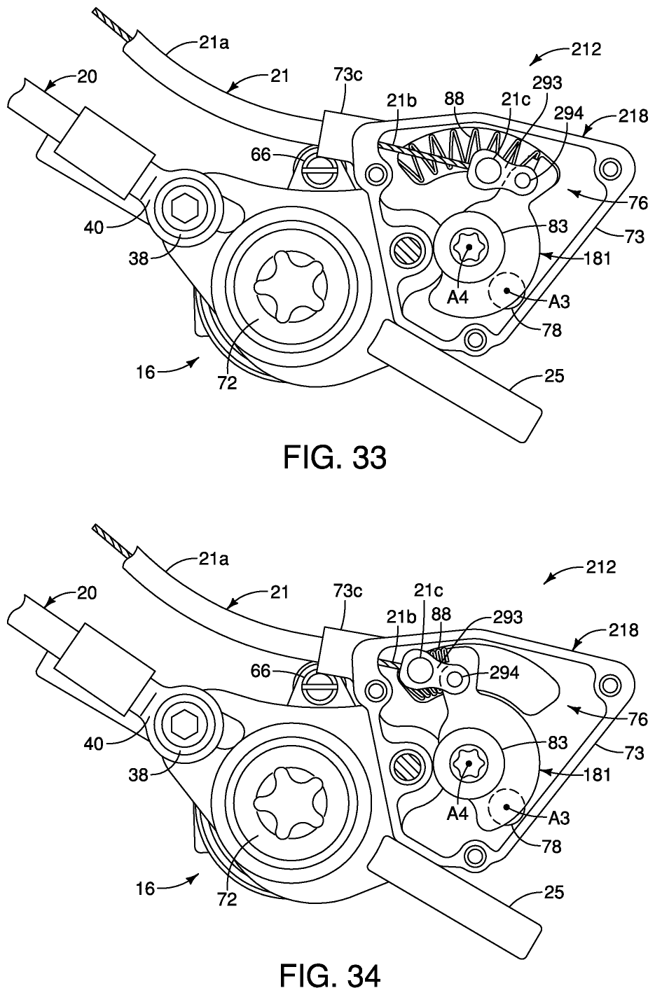

Referring now to FIGS. 33 and 34, a disc brake caliper 212 is illustrated in accordance with a third embodiment. The disc brake caliper 212 includes the hydraulic caliper body 16 of the first embodiment and a modified mechanical caliper body 218. In view of the similarity between the disc brake caliper 12 of the first embodiment and the disc brake caliper 212 of the third embodiment, the parts of the third embodiment that are identical to the parts of the first embodiment will be given the same reference numerals as the parts of the first embodiment. Moreover, the descriptions of the parts of the third embodiment that are identical to the parts of the first embodiment may be omitted for the sake of brevity.

Here, the disc brake caliper 212 is identical to the disc brake caliper 12 of the first embodiment, except that the intermediate member 81 of the disc brake caliper 12 has been replaced with an intermediate member 281 in the disc brake caliper 212 of the third embodiment. Specifically, the disc brake caliper 212 further comprises a cable attachment part 293 configured to be attached to the cable 21. The intermediate member 281 includes a part 294 coupled to the cable attachment part 293 to produce the variable rate of travel of the mechanical piston 78. Basically, the cable attachment part 293 is configured to at least partly move relative to the pivot axis A4 as the intermediate member 281 pivots about the pivot axis A4.

Here, the cable attachment part 293 is pivotally coupled to the intermediate member 281. For example, as in the third embodiment, the cable attachment part 293 is a cable retainer, and the part 294 is a pivot pin for pivotally attaching the cable attachment part 293 (e.g., the cable retainer) to the intermediate member 281. More specifically, in the third embodiment, the cable attachment part 293 is configured to retain the barrel shaped nipple 21c of the cable 21 to the intermediate member 281 via the part 294. During a braking operation, the cable attachment part 293 pivots relative to the intermediate member 281 such that the amount of angular rotation of the intermediate member 281 changes for a predetermine amount of the cable 21 being pulled with respect to the caliper housing 73. More specifically, the barrel shaped nipple 21c of the cable 21 moves away from the pivot axis A4 as the intermediate member 281 pivots about the pivot axis A4 during a braking operation. In other words, the cable attachment part 293 is configured to at least partly move away from the pivot axis A4 as the intermediate member 281 pivots about the pivot axis A4 during a braking operation. As a result, the mechanical piston 78 moves at a variable rate of travel relative to a travel of the cable 21 as the intermediate member 281 pivots about the pivot axis A4 during a braking operation. With this embodiment, the cam surface of the intermediate member 281 can have a constant inclination.

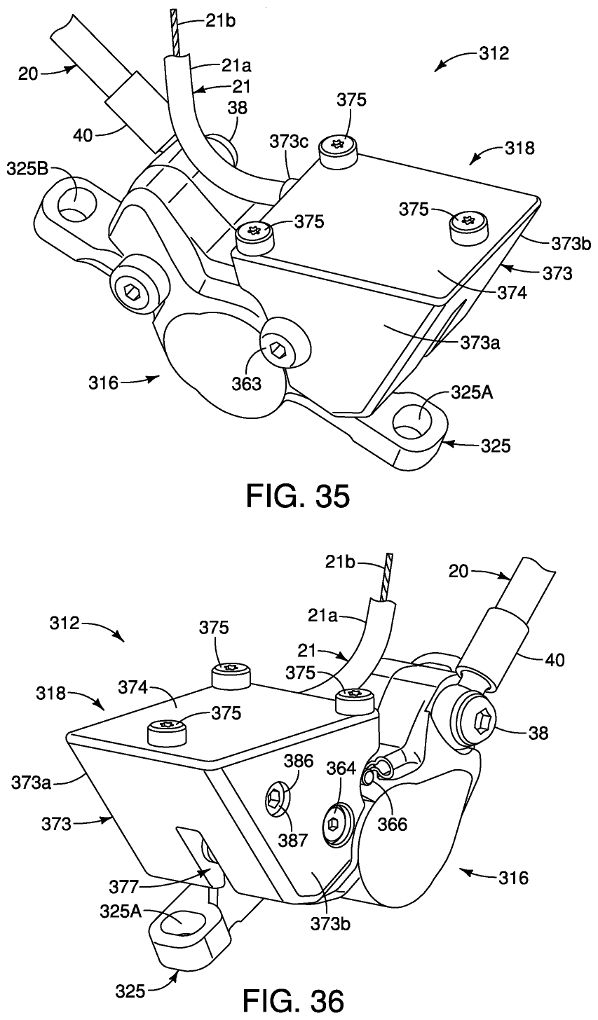

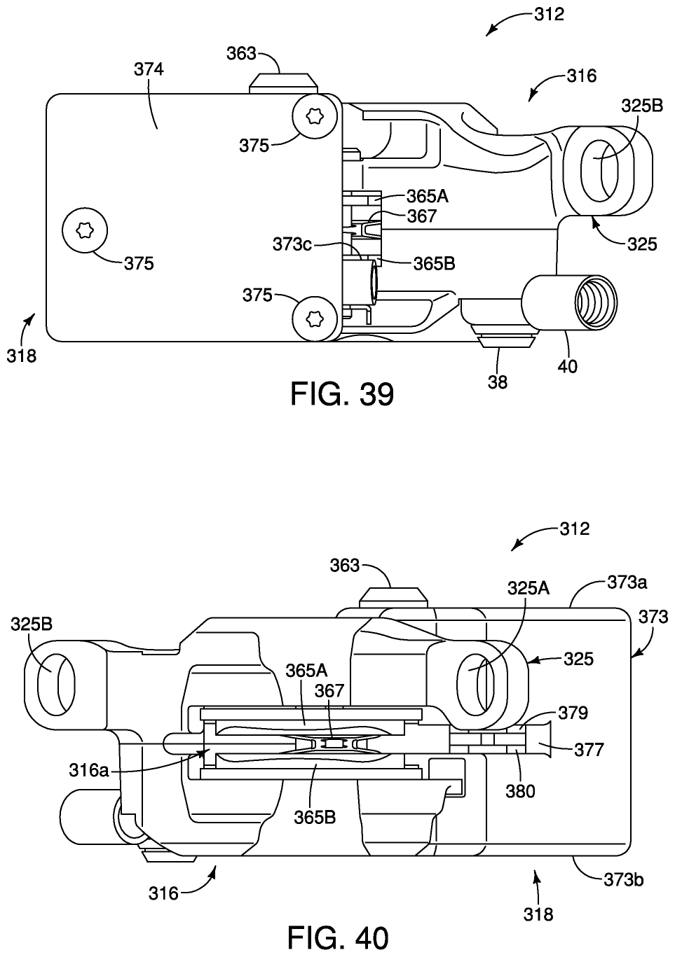

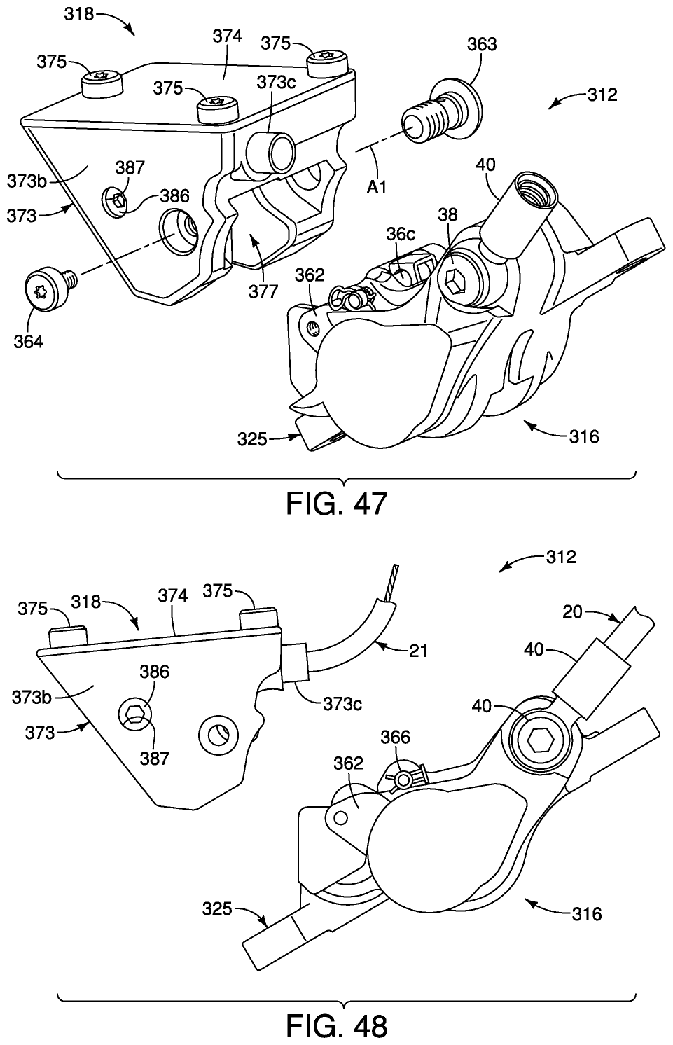

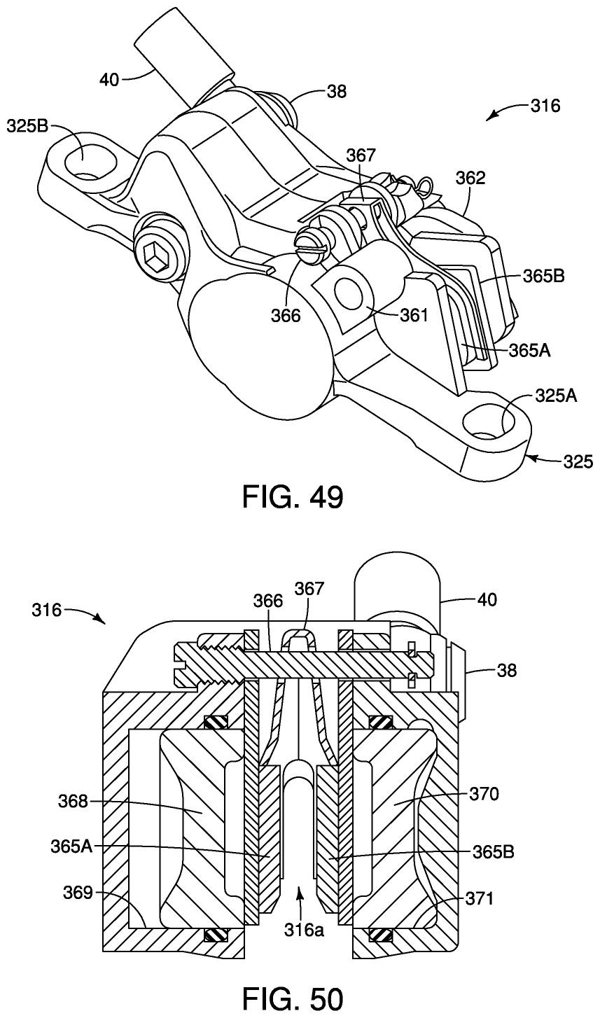

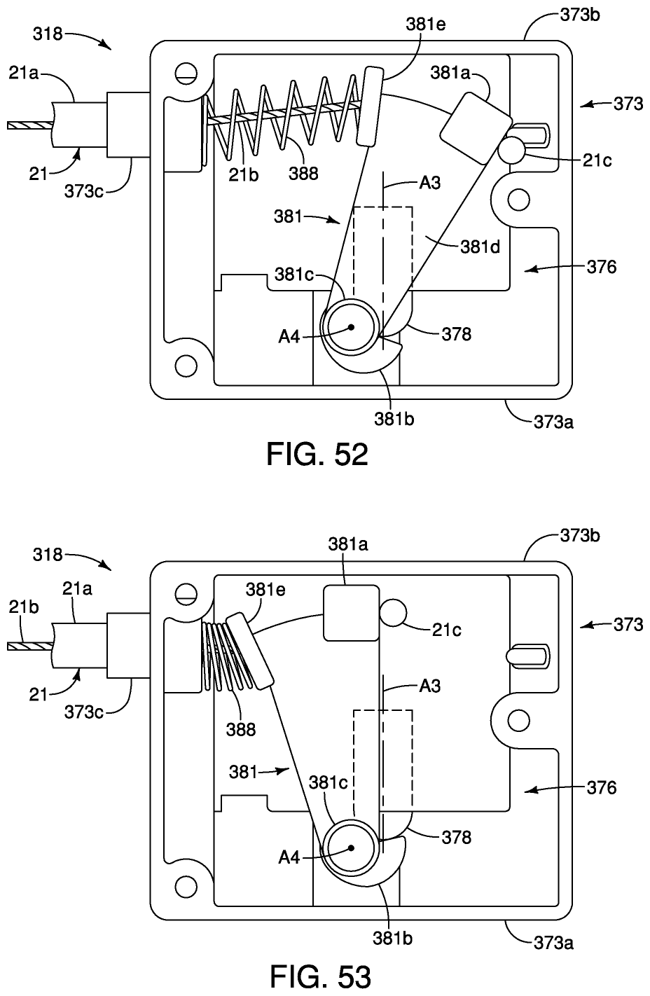

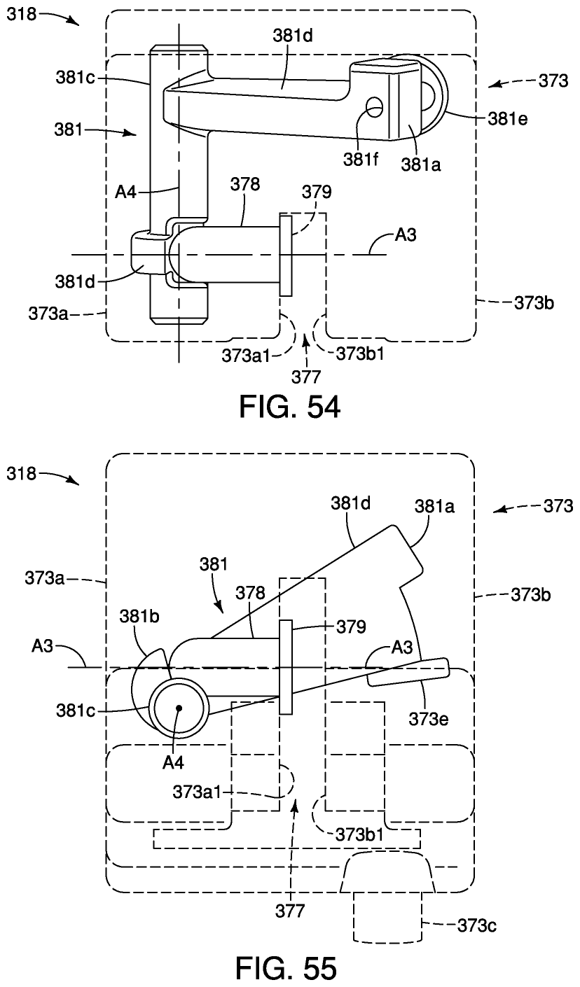

Referring now to FIGS. 35 to 55, a disc brake caliper 312 is illustrated in accordance with a fourth embodiment. The disc brake caliper 312 is mounted to the human-powered vehicle V in the same manner as the first embodiment. Basically, the disc brake caliper 312 comprises a hydraulic caliper body 316. Here, the disc brake caliper 312 comprises a mechanical caliper body 318. The hydraulic caliper body 316 is configured to be operated by a hydraulic fluid via the hydraulic hose 20, and the mechanical caliper body 318 is configured to be operated by the cable 21. In particular, the hydraulic caliper body 316 is operated by the brake operating device 14 in the same manner as the first embodiment. Thus, the disc brake caliper 312 is operatively coupled to the brake operating device 14 by the hydraulic hose 20 and the cable 21 in the same manner as the first embodiment to selectively grip (slow and/or stop rotation) of the disc brake rotor 22 that is fixedly attached to the hub of the wheel RW.

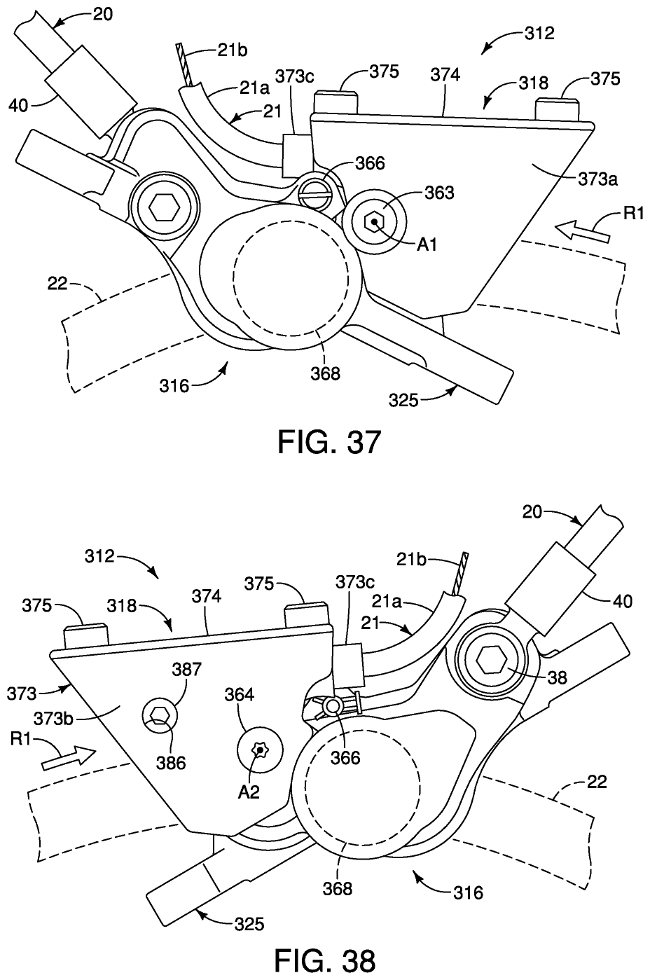

Referring now to FIGS. 35 to 42, the hydraulic caliper body 316 includes a coupling portion 325. The coupling portion 325 is configured to couple the hydraulic caliper body 316 to the vehicle body VB of the human-powered vehicle V. Here, for example, the coupling portion 325 includes a first coupling hole 325A and a second coupling hole 325B. The first coupling hole 325A and the second coupling hole 325B are through holes for receiving the fixing bolts therethrough. The first coupling hole 325A and the second coupling hole 325B are preferably elongated holes to allow for some adjustment of the hydraulic caliper body 316 relative to the vehicle body VB. The mechanical caliper body 318 is configured to be coupled to the vehicle body VB by the coupling portion 325 of the hydraulic caliper body 316. In other words, the mechanical caliper body 318 is not directed attached to the vehicle body VB. Rather, the mechanical caliper body 318 is supported to the vehicle body VB by the hydraulic caliper body 316. Here, as seen in FIG. 37, the mechanical caliper body 318 is positioned on an upstream side of the hydraulic caliper body 16 relative to the rotational direction R1 of the rotor 22.

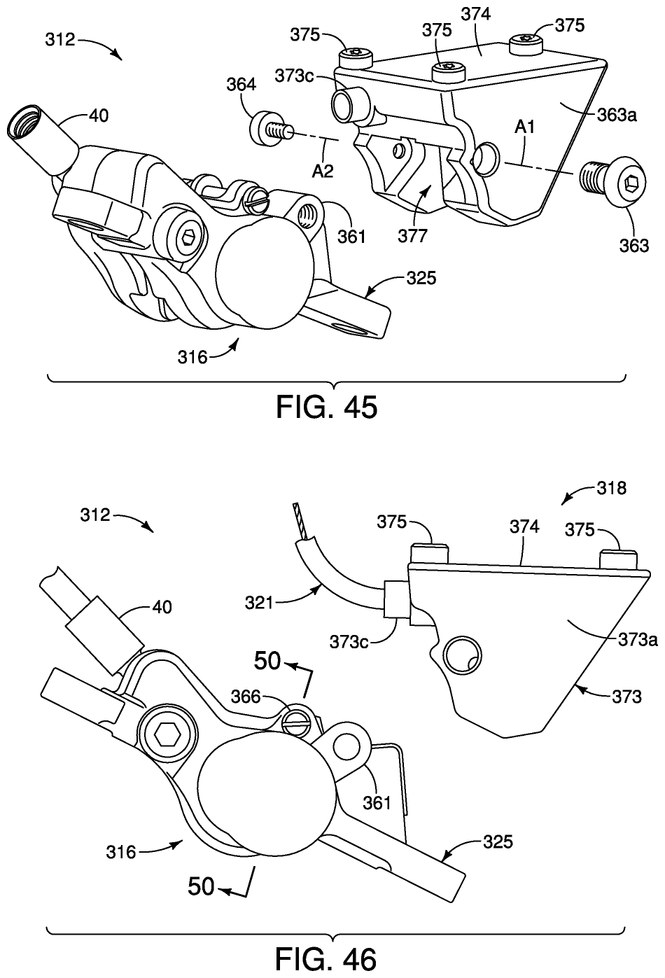

As seen in FIGS. 45 to 48, the hydraulic caliper body 316 includes a first attachment portion 361. Preferably, the hydraulic caliper body 316 further includes a second attachment portion 362. The first attachment portion 361 is provided on an outbound side S1 of the hydraulic caliper body 316 and the second attachment portion 362 is provided on an inbound side S2 of the hydraulic caliper body 316. The first attachment portion 361 is configured to couple the mechanical caliper body 318. Here, the first attachment portion 361 is configured to be attached to the mechanical caliper body 318. Specifically, the first attachment portion 361 is configured to detachably couple the mechanical caliper body 318 thereto. The second attachment portion 362 is configured to be attached to the mechanical caliper body 318. The second attachment portion 362 is offset from the first attachment portion 361. The disc brake caliper 312 further comprises a first fixing member 363 configured to detachably couple the mechanical caliper body 318 to the first attachment portion 361 of the hydraulic caliper body 316. The disc brake caliper 312 further comprises a second fixing member 364 configured to detachably attach the second attachment portion 362 to the mechanical caliper body 318. The first fixing member 363 has a first fixing axis A1 and the second fixing member 364 has a second fixing axis A2 that is parallel to the first fixing axis A1 in a state where the first fixing member 363 and the second fixing member 364 are attached to the hydraulic caliper body 316.

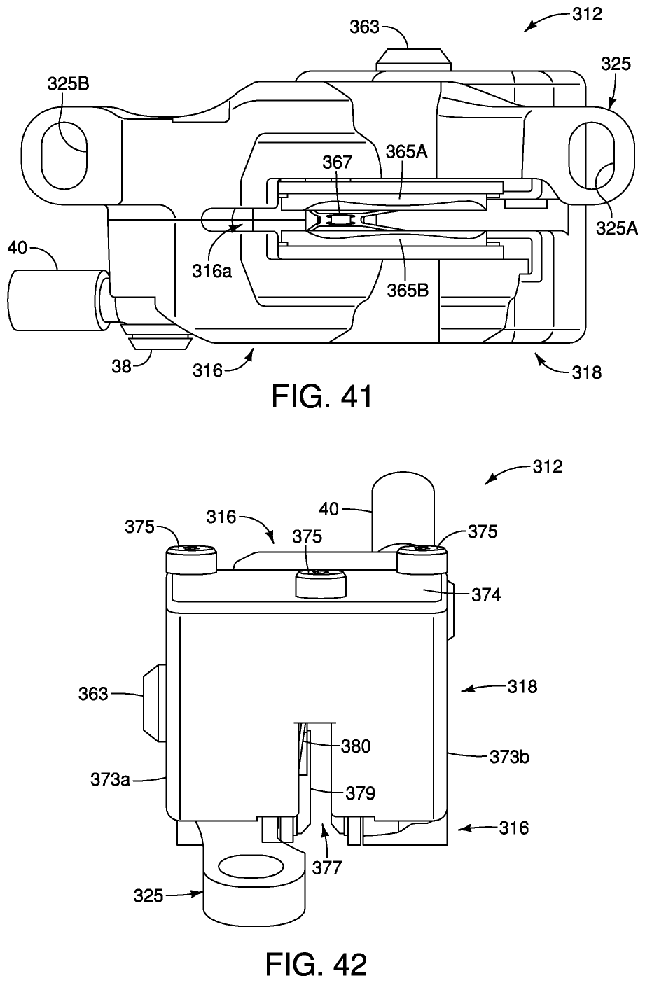

As seen in FIGS. 40 to 41, the disc brake caliper 312 further comprises a first brake pad 365A and a second brake pad 365B. The first brake pad 365A and the second brake pad 365B are movably coupled to the hydraulic caliper body 16 by a connecting pin 366. The hydraulic caliper body 316 has a rotor receiving slot 316a. The first brake pad 365A and the second brake pad 365B are disposed in the rotor receiving slot 316a. In particular, the first brake pad 365A is located on one side of the rotor receiving slot 316a, and the second brake pad 365B is located on the other side of the rotor receiving slot 316a. The disc brake caliper 312 further comprises a biasing element 367 operatively disposed between the first brake pad 365A and the second brake pad 365B to maintain the rotor receiving slot 316a in a state where the second brake lever 30 is in the non-operated position.

Referring to FIG. 50, the disc brake caliper 312 further comprises a first hydraulic piston 368. The first brake pad 365A can be bonded to the first hydraulic piston 368 as needed and/or desired. Alternatively, the first brake pad 365A is maintained in contact with the first hydraulic piston 368 by the biasing element 367. In any case, the biasing element 367 applies a biasing force to the first brake pad 365A and the first hydraulic piston 368 so that the first brake pad 365A and the first hydraulic piston 368 do not contact the rotor 22 where the second brake lever 30 is in the non-operated position. The first hydraulic piston 368 is configured to be operated by a hydraulic fluid. The first hydraulic piston 368 is movably provided in the hydraulic caliper body 316. In particular, the hydraulic caliper body 316 includes a first cylinder 369. The first hydraulic piston 368 is movably provided in the first cylinder 369. The first cylinder 369 is fluidly connected to the hydraulic hose 20 via internal passageways form in the hydraulic caliper body 316. The first hydraulic piston 368 moves the first brake pad 365A into contact with the rotor 322. In other words, upon operation of the second brake lever 30, the first hydraulic piston 368 moves the first brake pad 365A into contact with the rotor 22.

Still referring back to FIG. 50, the disc brake caliper 312 further comprises a second hydraulic piston 370. The second hydraulic piston 370 is movably provided in a second cylinder 371 of the hydraulic caliper body 316 to move the second brake pad 365B into contact with the rotor 22. The second brake pad 365B can be bonded to the second hydraulic piston 370 as needed and/or desired. Alternatively, the second brake pad 365B is maintained in contact with the second hydraulic piston 370 by the biasing element 367. In any case, the biasing element 367 applies a biasing force to the second brake pad 365B and the second hydraulic piston 370 so that the second brake pad 365B and the second hydraulic piston 370 do not contact the rotor 22 where the second brake lever 30 is in the non-operated position. The second cylinder 371 is fluidly connected to the hydraulic hose 20 via internal passageways form in the hydraulic caliper body 316. Thus, upon operation of the second brake lever 30, the second hydraulic piston 370 moves the second brake pad 365B into contact with the rotor 22. Alternatively, the second hydraulic piston 370 and the second cylinder 371 can be omitted and the second brake pad 365B can be a stationary brake pad that is bonded to the hydraulic caliper body 316.

Here, the first hydraulic piston 368 and the second hydraulic piston 370 are hydraulically operated pistons. Accordingly, the first hydraulic piston 368 and the second hydraulic piston 370 are movably mounted to the hydraulic caliper body 16 such that the first hydraulic piston 368 and the second hydraulic piston 370 move the first brake pad 65A and the second brake pad 65B. In particular, the first hydraulic piston 368 and the second hydraulic piston 370 are configured to move relative to the hydraulic caliper body 316 in response to operation of the second brake lever 30. Thus, the first hydraulic piston 368 and the second hydraulic piston 370 are configured to move the first brake pad 365A and the second brake pad 365B to contact the disc brake rotor 22 in response to the second brake lever 30 being operated from the rest position (i.e., the non-braking position) to the operated position (i.e., the braking position). In other words, when the second brake lever 30 is operated by a user, the first hydraulic piston 368 and the second hydraulic piston 370 are moved relative to the hydraulic caliper body 316 to move the first brake pad 365A and the second brake pad 365B into contact with the disc brake rotor 22. Thus, the first brake pad 365A and the second brake pad 365B contact the disc brake rotor 22 to apply a braking force to the disc brake rotor 22 in response to operation of the second brake lever 30.

Here, the hydraulic caliper body 316 is primarily constructed of two parts that are bolts and/or bonded together. The hydraulic caliper body 316 is preferably constructed of a hard, rigid material, such as a metallic material.

Referring to FIGS. 42 to 48 and 51, the mechanical caliper body 318 includes a caliper housing 373. The mechanical caliper body 318 further includes a lid 374 detachably coupled to the caliper housing 373. Here, the lid 374 is detachably coupled to the caliper housing 373 by at least one fastener 375 (e.g., threaded fasteners such as bolts). The lid 374 is detachably coupled to the caliper housing 373 by three fasteners. The caliper housing 373 has an interior space 376. The lid 374 is removed from the caliper housing 373 to access the interior space 376. The lid 374 is attached to the caliper housing 373 to close off access the interior space 376.

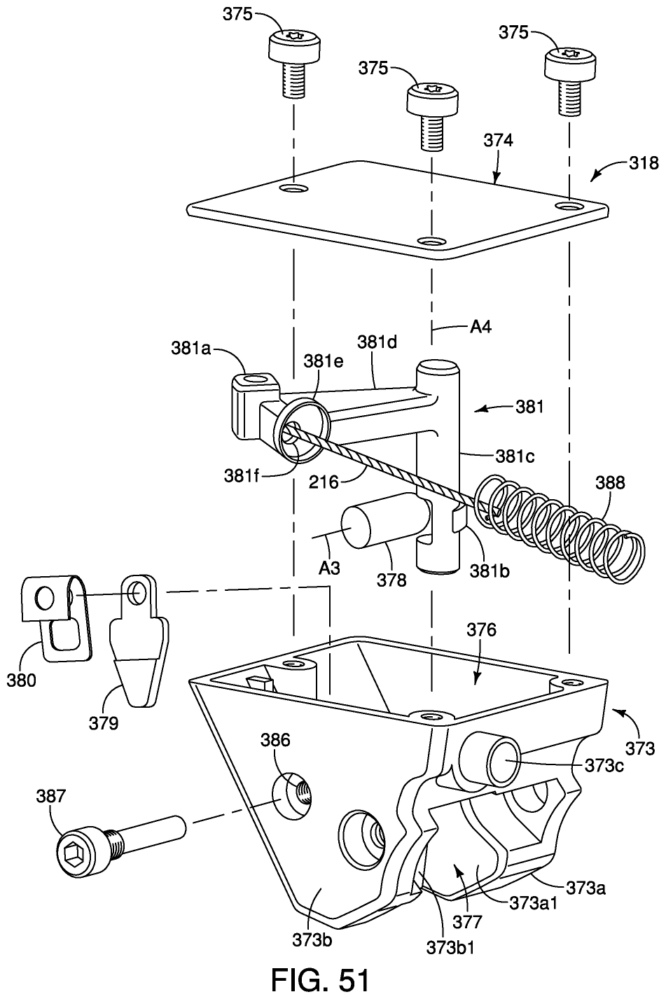

Referring to FIG. 51, the caliper housing 373 defines a rotor receiving slot 377. The caliper housing 373 includes an outbound portion 373a having a first inner surface 373a1 defining a first side of the rotor receiving slot 377, and an inbound portion 373b having a second inner surface 373b1 defining a second side of the rotor receiving slot 377. The caliper housing 373 has a cable port 373c provided on an inbound side of the rotor receiving slot 377. The cable port 373c is configured to abut the outer casing 21a of the cable 21 and to allow the inner wire 21b of the cable 21 to pass therethrough. The cable port 373c can be threaded to receive a cable adjuster as needed and/or desired.

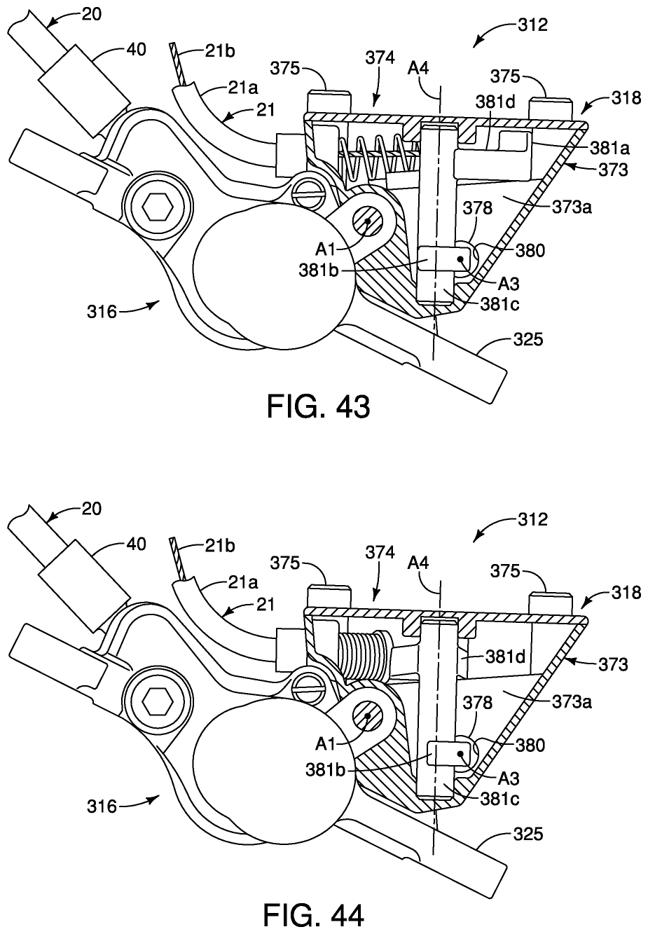

Referring back to FIGS. 43 and 44, the disc brake caliper 312 comprises a mechanical piston 378. The mechanical piston 378 is movably provided in the mechanical caliper body 318. Here, the outbound portion 373a has a piston bore 380. The mechanical piston 378 is slidably disposed in the piston bore 380. The mechanical piston 378 is configured to move along a mechanical piston axis A3. Basically, the mechanical piston 378 is configured to move a brake pad into contact with the rotor 22. In particular, the mechanical piston 378 is configured to move an auxiliary brake pad 379 into contact with the rotor 22. The disc brake caliper 312 further comprises a mechanical piston biasing element 380 configured to bias the mechanical piston 378 towards a non-actuated position. More specifically, the mechanical piston biasing element 380 biases the auxiliary brake pad 379 towards a non-actuated position, which in turn biases the mechanical piston 378 towards the non-actuated position.

Referring back to FIG. 51, the disc brake caliper 312 comprises an intermediate member 381. The mechanical caliper body 318 entirely covers the intermediate member 381 and covers a majority of the mechanical piston 378. In particular, the intermediate member 381 is disposed in the interior space 376. The intermediate member 381 is movably provided in the mechanical caliper body 318. Here, the intermediate member 381 has a cable attachment portion 381a configured to be coupled to the cable 321. The intermediate member 381 is configured to move the mechanical piston 378 in response to movement of the cable 21 during a braking operation. In particular, the intermediate member 381 further includes a cam portion 381b configured to move the mechanical piston 378.

The intermediate member 381 is configured to pivot about a pivot axis A4.

Specifically, the intermediate member 381 is pivotally provided in the mechanical caliper body 318 about the pivot axis A4. More specifically, the intermediate member 381 includes a first shaft 381c pivotally mounted to the mechanical caliper body 318 and defining the pivot axis A4. In the third embodiment, the cam portion 381b is provided on the first shaft 381c. Here, the cable attachment portion 381a, the cam portion 381b and the first shaft 381c are integrally formed as a one-piece member. Alternatively, the cable attachment portion 381a, the cam portion 381b and the first shaft 381c can be separate members that are coupled together. A lower end of the first shaft 383 is pivotally supported in the caliper housing 373, while an upper end of the first shaft 381c is pivotally supported in the lid 374. In this way, the intermediate member 381 is pivotally supported to the mechanical caliper body 318 by the first shaft 381c. The pivot axis A4 is different from the mechanical piston axis A3. Here, in the third embodiment, the pivot axis A4 is not parallel to the mechanical piston axis A3. Preferably, the pivot axis A4 is perpendicularly arranged relative to the mechanical piston axis A3.

The intermediate member 381 further includes an actuating arm 381d extending radially from the first shaft 381c with respect to the pivot axis A4 of the first shaft 381c. The actuating arm 381d includes the cable attachment portion 381a at a position spaced from the pivot axis A4. The cable attachment portion 381a, the cam portion 381b, the first shaft 381c and the actuating arm 381d are a one-piece member. Thus, the cable attachment portion 381a, the cam portion 381b, the first shaft 381c and the actuating arm 381d are integrally formed as a part of the intermediate member 81.

The caliper housing 373 includes a second shaft support recess 386. The second shaft support recess 386 is configured to receive a brake pad shaft 387. The brake pad shaft 387 movably supports the auxiliary brake pad 379 with respect to the caliper housing 373. Here, the brake pad shaft 387 supports the mechanical piston biasing element 380 to the caliper housing 373.

The disc brake caliper 312 further comprises a biasing element 388. The biasing element 388 is configured to bias the intermediate member 381 to a non-actuated position. Here, the biasing element 388 is disposed between the caliper housing 373 and the intermediate member 381. In particular, the intermediate member 381 includes an abutment portion 381e for abutting against one end of the biasing element 388. The other end of the biasing element 388 abuts against an inner surface of the caliper housing 373. In the illustrated embodiment, for example, the biasing element 388 is a coiled compression spring that is compressed during a braking operation. Thus, the biasing element 388 acts as a return spring to return intermediate member 381 to the non-actuated position. Also, in the illustrated embodiment, the inner wire 21b of the cable 21 passes through the coils of the biasing element 388. Here, a bore 381f is provided in the cable attachment portion 381a and the abutment portion 381e of the intermediate member 381 for receiving the inner wire 21b of the cable 21 therethrough.

Basically, during a braking operation of the mechanical caliper body 318, a user operates the first brake lever 28 to pull the inner wire 21b of the cable 21 with respect to the mechanical caliper body 318. The pulling of the inner wire 21b of the cable 21 rotates the intermediate member 381 about the pivot axis A4. The rotation of the intermediate member 381 causes the cam portion 381b to move the mechanical piston 378 linearly along the mechanical piston axis A3. The linear movement of the mechanical piston 378 cause the auxiliary brake pad 379 to engage the rotor 22 to apply a braking force to the rotor 22.

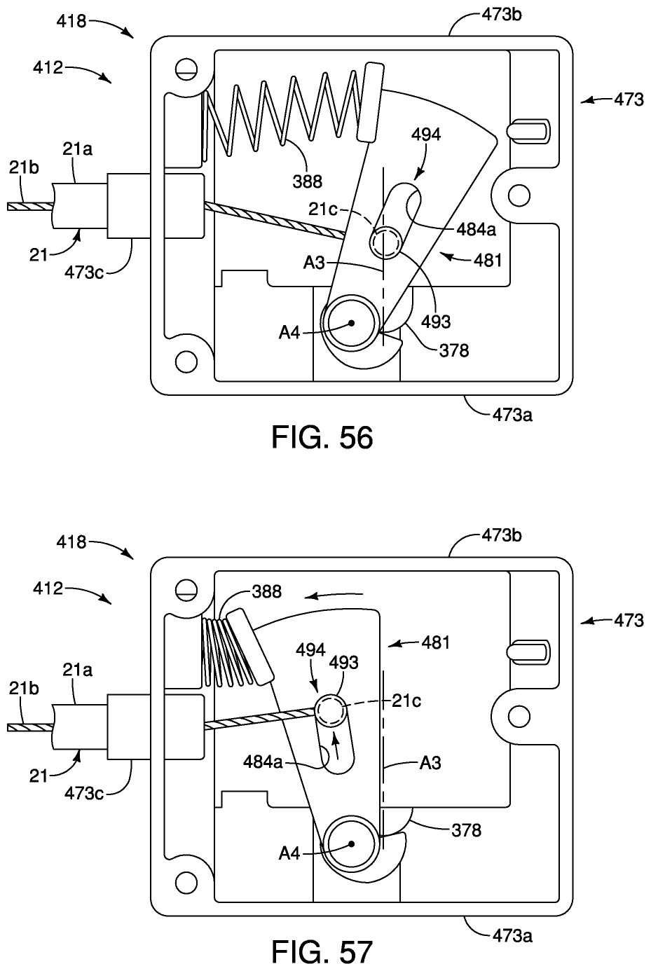

Referring now to FIGS. 56 and 57, a disc brake caliper 412 is illustrated in accordance with a fifth embodiment. The disc brake caliper 412 includes the hydraulic caliper body 316 (see FIGS. 45 to 50) of the third embodiment and a modified mechanical caliper body 418. In view of the similarity between the disc brake caliper 312 of the fourth embodiment and the disc brake caliper 412 of the fifth embodiment, the parts of the fifth embodiment that are identical to the parts of the fourth embodiment will be given the same reference numerals as the parts of the fourth embodiment. Moreover, the descriptions of the parts of the fifth embodiment that are identical to the parts of the fourth embodiment may be omitted for the sake of brevity.

Here, the disc brake caliper 412 is identical to the disc brake caliper 412 of the fourth embodiment, except that the caliper housing 373 and the intermediate member 381 of the disc brake caliper 312 has been replaced with a caliper housing 473 and an intermediate member 481 in the disc brake caliper 412 of the fifth embodiment. Specifically, the caliper housing 473 includes an outbound portion 473a, an inbound portion 473b and a cable port 473c. The caliper housing 473 is identical to the caliper housing 373, except that the caliper housing 473 has been modified to accommodate a change in the position of the cable port 473c. The intermediate member 481 is identical to the intermediate member 381, except that the cable attachment portion 381a has been omitted such that the end of the cable 21 is attached to the intermediate member 481 to produce the variable rate of travel of the mechanical piston 378. Specifically, the disc brake caliper 412 further comprises a cable attachment part 493 configured to be attached to the cable 21. The intermediate member 481 includes a part 494 coupled to the cable attachment part 493 to produce the variable rate of travel of the mechanical piston 378. Basically, the cable attachment part 493 is configured to at least partly move relative to the pivot axis A4 as the intermediate member 481 pivots about the pivot axis A4. The part 494 includes a contact surface 494a. The contact surface 494a is configured to slidably contact the cable attachment part 493 to produce the variable rate of travel of the mechanical piston 78. More specifically, in the second embodiment, the cable attachment part 493 includes a cable retainer configured to retain the barrel shaped nipple 21c of the cable 21, and the contact surface 494a is formed by a slot that slidably receives the cable retainer (i.e., the cable attachment part 493). The cable retainer has a cylindrical shape. The cable retainer includes a container space configured to hold the barrel shaped nipple 21c and an attachment through hole configured to allow the inner wire 21b of the cable 21 to pass therethrough. The cable attachment part 493 can include the barrel shaped nipple 21c of the cable 21, and the contact surface 494a can be formed by a slot that slidably receives the barrel shaped nipple 21c of the cable 21. The contact surface 494a (e.g., the slot) is orientated relative to the pivot axis A4 of the intermediate member 481 so that the barrel shaped nipple 21c of the cable 21 moves away from the pivot axis A4 as the intermediate member 481 pivots about the pivot axis A4 during a braking operation. In this way, the cable attachment part 493 is configured to at least partly move away from the pivot axis A4 as the intermediate member 481 pivots about the pivot axis A4 during a braking operation. As a result, the mechanical piston 78 moves at a variable rate of travel relative to a travel of the cable 21 as the intermediate member 481 pivots about the pivot axis A4 during a braking operation.

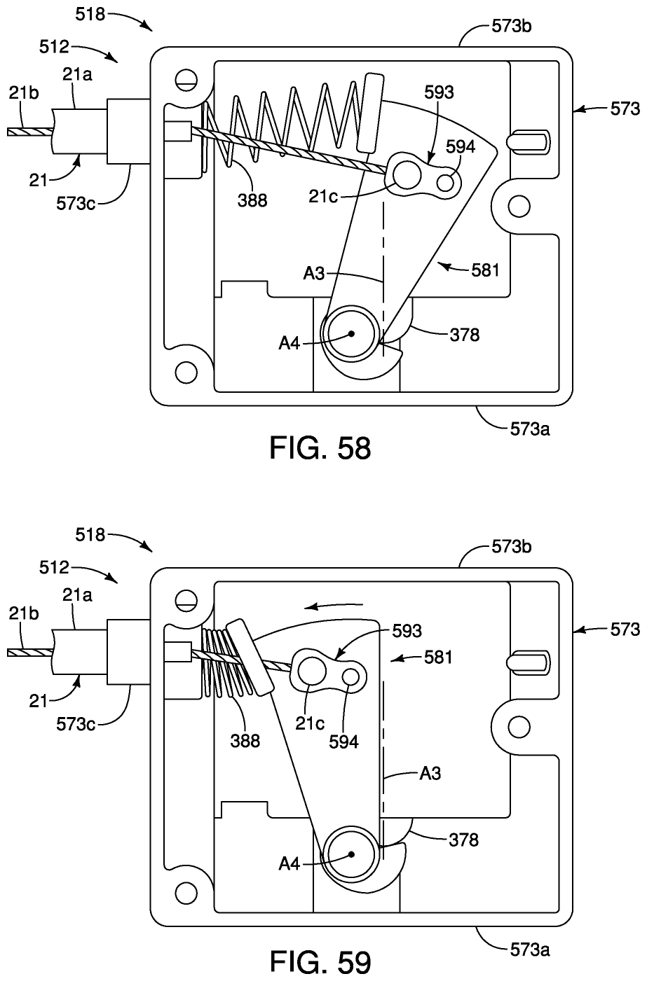

Referring now to FIGS. 58 and 59, a disc brake caliper 512 is illustrated in accordance with a sixth embodiment. The disc brake caliper 512 includes the hydraulic caliper body 316 (see FIGS. 45 to 50) of the third embodiment and a modified mechanical caliper body 518. In view of the similarity between the disc brake caliper 312 of the fourth embodiment and the disc brake caliper 512 of the sixth embodiment, the parts of the sixth embodiment that are identical to the parts of the fourth embodiment will be given the same reference numerals as the parts of the fourth embodiment. Moreover, the descriptions of the parts of the sixth embodiment that are identical to the parts of the fourth embodiment may be omitted for the sake of brevity.

Here, the disc brake caliper 512 is identical to the disc brake caliper 312 of the fourth embodiment, except that the caliper housing 373 and the intermediate member 381 of the disc brake caliper 312 has been replaced with a caliper housing 573 and an intermediate member 581 in the disc brake caliper 512 of the fifth embodiment. Specifically, the caliper housing 573 includes an outbound portion 573a, an inbound portion 573b and a cable port 573c. The caliper housing 573 is identical to the caliper housing 373, except that the caliper housing 573 has been modified to accommodate a change in the position of the cable port 573c. The intermediate member 581 is identical to the intermediate member 581, except that the cable attachment portion 581a has been omitted such that the end of the cable 21 is attached to the intermediate member 581 to produce the variable rate of travel of the mechanical piston 378. Specifically, the disc brake caliper 512 further comprises a cable attachment part 593 configured to be attached to the cable 21. The intermediate member 581 includes a part 594 coupled to the cable attachment part 593 to produce the variable rate of travel of the mechanical piston 378. Basically, the cable attachment part 593 is configured to at least partly move relative to the pivot axis A4 as the intermediate member 581 pivots about the pivot axis A4.

Here, the cable attachment part 593 is pivotally coupled to the intermediate member 581. For example, as in the sixth embodiment, the cable attachment part 593 is a cable retainer, and the part 594 is a pivot pin for pivotally attaching the cable attachment part 593 (e.g., the cable retainer) to the intermediate member 581. More specifically, in the third embodiment, the cable attachment part 593 is configured to retain the barrel shaped nipple 21c of the cable 21 to the intermediate member 581 via the part 594. During a braking operation, the cable attachment part 593 pivots relative to the intermediate member 581 such that the amount of angular rotation of the intermediate member 581 changes for a predetermine amount of the cable 21 being pulled with respect to the caliper housing 373. More specifically, the barrel shaped nipple 21c of the cable 21 moves away from the pivot axis A4 as the intermediate member 581 pivots about the pivot axis A4 during a braking operation. In other words, the cable attachment part 593 is configured to at least partly move away from the pivot axis A4 as the intermediate member 581 pivots about the pivot axis A4 during a braking operation. As a result, the mechanical piston 78 moves at a variable rate of travel relative to a travel of the cable 21 as the intermediate member 581 pivots about the pivot axis A4 during a braking operation.

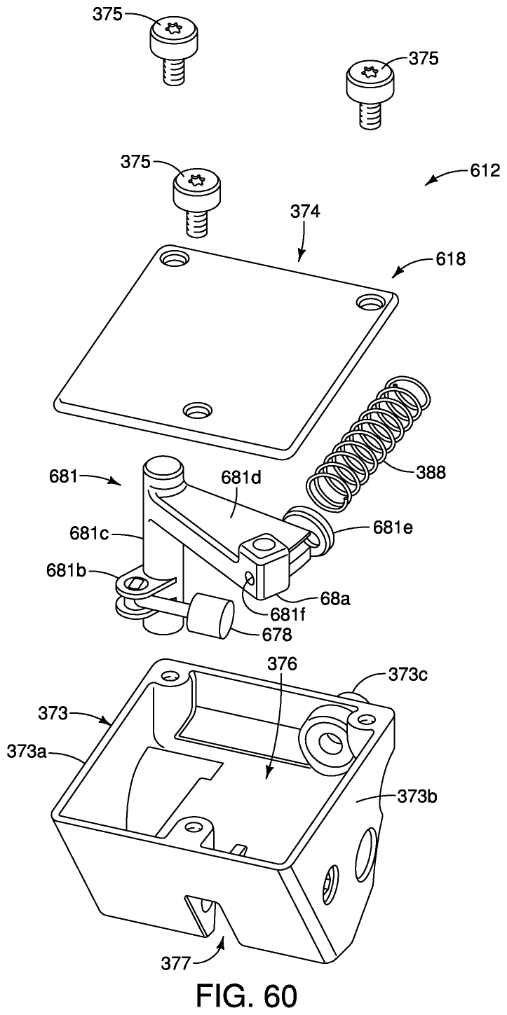

Referring now to FIG. 60, a disc brake caliper 612 is illustrated in accordance with a seventh embodiment. The disc brake caliper 612 includes the hydraulic caliper body 316 (see FIGS. 45 to 50) of the third embodiment and a modified mechanical caliper body 618. In view of the similarity between the disc brake caliper 312 of the fourth embodiment and the disc brake caliper 612 of the seventh embodiment, the parts of the seventh embodiment that are identical to the parts of the fourth embodiment will be given the same reference numerals as the parts of the fourth embodiment. Moreover, the descriptions of the parts of the seventh embodiment that are identical to the parts of the fourth embodiment may be omitted for the sake of brevity.

Here, the disc brake caliper 612 is identical to the disc brake caliper 312 of the fourth embodiment, except that the mechanical piston 378 and the intermediate member 381 of the disc brake caliper 312 has been replaced with a mechanical piston 678 and an intermediate member 681 in the disc brake caliper 612 of the seventh embodiment. Specifically, here, the mechanical piston 678 is linked to the intermediate member 681. More specially, the mechanical piston 678 is pivotally coupled to the intermediate member 681. Thus, in this the mechanical piston biasing element can be omitted. Rather, the biasing element 388 applies a biasing force to bias both the mechanical piston 678 and the intermediate member 681 towards the non-operated (non-braking) position.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts unless otherwise stated.

As used herein, the following directional terms “frame facing side”, “non-frame facing side”, “forward”, “rearward”, “front”, “rear”, “up”, “down”, “above”, “below”, “upward”, “downward”, “top”, “bottom”, “side”, “vertical”, “horizontal”, “perpendicular” and “transverse” as well as any other similar directional terms refer to those directions of a human-powered vehicle (e.g., bicycle) in an upright, riding position and equipped with the disc brake caliper. Accordingly, these directional terms, as utilized to describe the disc brake caliper should be interpreted relative to a human-powered vehicle (e.g., bicycle) in an upright riding position on a horizontal surface and that is equipped with the disc brake caliper. The terms “left” and “right” are used to indicate the “right” when referencing from the right side as viewed from the rear of the human-powered vehicle (e.g., bicycle), and the “left” when referencing from the left side as viewed from the rear of the human-powered vehicle (e.g., bicycle).

The phrase “at least one of” as used in this disclosure means “one or more” of a desired choice. For one example, the phrase “at least one of” as used in this disclosure means “only one single choice” or “both of two choices” if the number of its choices is two. For another example, the phrase “at least one of” as used in this disclosure means “only one single choice” or “any combination of equal to or more than two choices” if the number of its choices is equal to or more than three. Also, the term “and/or” as used in this disclosure means “either one or both of”. For instance, the phrase “at least one of A and B” encompasses (1) A alone, (2), B alone, and (3) both A and B. The phrase “at least one of A, B, and C” encompasses (1) A alone, (2), B alone, (3) C alone, (4) both A and B, (5) both B and C, (6) both A and C, and (7) all A, B, and C. In other words, the phrase “at least one of A and B” does not mean “at least one of A and at least one of B” in this disclosure.

Also, it will be understood that although the terms “first” and “second” may be used herein to describe various components, these components should not be limited by these terms. These terms are only used to distinguish one component from another. Thus, for example, a first component discussed above could be termed a second component and vice versa without departing from the teachings of the present invention.

The term “attached” or “attaching”, as used herein, encompasses configurations in which an element is directly secured to another element by affixing the element directly to the other element; configurations in which the element is indirectly secured to the other element by affixing the element to the intermediate member(s) which in turn are affixed to the other element; and configurations in which one element is integral with another element, i.e. one element is essentially part of the other element. This definition also applies to words of similar meaning, for example, “joined”, “connected”, “coupled”, “mounted”, “bonded”, “fixed” and their derivatives. Finally, terms of degree such as “substantially”, “about” and “approximately” as used herein mean an amount of deviation of the modified term such that the end result is not significantly changed.

While only selected embodiments have been chosen to illustrate the present invention, it will be apparent to those skilled in the art from this disclosure that various changes and modifications can be made herein without departing from the scope of the invention as defined in the appended claims. For example, unless specifically stated otherwise, the size, shape, location or orientation of the various components can be changed as needed and/or desired so long as the changes do not substantially affect their intended function. Unless specifically stated otherwise, components that are shown directly connected or contacting each other can have intermediate structures disposed between them so long as the changes do not substantially affect their intended function. The functions of one element can be performed by two, and vice versa unless specifically stated otherwise. The structures and functions of one embodiment can be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the foregoing descriptions of the embodiments according to the present invention are provided for illustration only, and not for the purpose of limiting the invention as defined by the appended claims and their equivalents.

What is claimed is:

1. A disc brake caliper for a human-powered vehicle, the disc brake caliper comprising:
a hydraulic caliper body including a first cylinder and a first attachment portion configured to couple a mechanical caliper body being configured to be operated by a cable; and
a first hydraulic piston movably provided in the first cylinder to move a first brake pad into contact with a rotor, the first hydraulic piston being configured to be operated by a hydraulic fluid.

2. The disc brake caliper according to claim 1, wherein
the first attachment portion is configured to detachably couple the mechanical caliper body thereto.

3. The disc brake caliper according to claim 2, further comprising
a first fixing member configured to detachably couple the mechanical caliper body to the first attachment portion of the hydraulic caliper body.

4. The disc brake caliper according to claim 2, wherein
the hydraulic caliper body further includes a second attachment portion that is offset from the first attachment portion.

5. The disc brake caliper according to claim 4, wherein
the first attachment portion is provided on an outbound side of the hydraulic caliper body and the second attachment portion is provided on an inbound side of the hydraulic caliper body.

6. The disc brake caliper according to claim 4, further comprising
a second fixing member configured to detachably attach the second attachment portion to the mechanical caliper body.

7. The disc brake caliper according to claim 6, wherein
the first fixing member has a first fixing axis and the second fixing member has a second fixing axis that is parallel to the first fixing axis in a state where the first fixing member and the second fixing member are attached to the hydraulic caliper body.

8. The disc brake caliper according to claim 1, further comprising
the mechanical caliper body coupled to the hydraulic caliper body.

9. The disc brake caliper according to claim 8, wherein
the mechanical caliper body is positioned on an upstream side of the hydraulic caliper body relative to a rotational direction of the rotor.

10. The disc brake caliper according to claim 8, further comprising
a mechanical piston movably provided in the mechanical caliper body and configured to move a brake pad into contact with the rotor.

11. The disc brake caliper according to claim 10, further comprising
an intermediate member movably provided in the mechanical caliper body and having a cable attachment portion configured to be coupled to a cable, the intermediate member being configured to move the mechanical piston in response to movement of the cable during a braking operation.

12. The disc brake caliper according to claim 8, wherein
the mechanical caliper body includes a caliper housing defining a rotor receiving slot.

13. The disc brake caliper according to claim 12, wherein
the caliper housing has an interior space, and the intermediate member is disposed in the interior space.

14. The disc brake caliper according to claim 12, wherein
the mechanical caliper body includes a lid detachably coupled to the caliper housing.

15. The disc brake caliper according to claim 12, wherein
the caliper housing has a cable port provided on an inbound side of the rotor receiving slot.

16. The disc brake caliper according to claim 12, wherein
the caliper housing includes an outbound portion having a first inner surface defining a first side of the rotor receiving slot, and an inbound portion having a second inner surface defining a second side of the rotor receiving slot.

17. The disc brake caliper according to claim 16, wherein
the outbound portion has a piston bore, and the mechanical piston is slidably disposed in the piston bore.

18. The disc brake caliper according to claim 16, wherein
the intermediate member is pivotally supported to the outbound portion by a first shaft, and
the outbound portion has a first shaft support recess receiving the first shaft.

19. The disc brake caliper according to claim 18, wherein
the intermediate member further includes an actuating arm extending radially from the first shaft with respect to a pivot axis of the first shaft, the actuating arm includes the cable attachment portion at a position spaced from the pivot axis.

20. The disc brake caliper according to claim 12, wherein
the caliper housing includes a second shaft support recess configured to receive a brake pad shaft.

21. The disc brake caliper according to claim 11, wherein
the intermediate member further includes a first cam surface configured to move the mechanical piston.

22. The disc brake caliper according to claim 21, wherein
the cable attachment portion and the cam portion are a one-piece member.

23. The disc brake caliper according to claim 11, wherein
the intermediate member is configured to pivot about a pivot axis,
the mechanical piston is configured to move along a mechanical piston axis, and
the pivot axis is different from the mechanical piston axis.

24. The disc brake caliper according to claim 23, wherein
the pivot axis is not parallel to the mechanical piston axis.

25. The disc brake caliper according to claim 24, wherein
the pivot axis is perpendicularly arranged relative to the mechanical piston axis.

26. The disc brake caliper according to claim 11, further comprising
a biasing element configured to bias the intermediate member to a non-actuated position.

27. The disc brake caliper according to claim 1, further comprising
a second hydraulic piston movably provided in a second cylinder of the hydraulic caliper body to move a second brake pad into contact with the rotor.

28. The disc brake caliper according to claim 1, wherein
the hydraulic caliper body includes a coupling portion configured to couple the hydraulic caliper body to a vehicle body of the human-powered vehicle.

29. The disc brake caliper according to claim 28, wherein
the coupling portion includes a first coupling hole and a second coupling hole.
